(19) United States
(12) Patent Application Publication
(10) Pub. No.: US 2026/0285175 A1
(43) Pub. Date: Sep. 24, 2026

(54) Cable Management System for an Electric Vehicle Charger

(71) Applicants: Scott Nielson, Salt Lake City, UT (US); Jacob L. Nielson, Salt Lake City, UT (US)

(72) Inventors: Scott Nielson, Fruit Heights, UT (US); Jacob L. Nielson, O'Fallon, MO (US); Parker Dahl, Mendon, UT (US); Asa DeBuck, Vineyard, UT (US); Andrew Chase Norton, Logan, UT (US); Manjunatha Prasad Rajashekara Murthy, South Jordan, UT (US); Phil Utykanski, Saratoga Springs, UT (US)

(21) Appl. No.: 19/490,930

(22) PCT Filed: Jun. 6, 2024
(86) PCT No.: PCT/US2024/032889

§ 371 Date: Dec. 6, 2025

Related U.S. Application Data
(60) Provisional application No. 63/506,365, filed on Jun. 6, 2023.

(51) Int. Cl. B60L 53/18; B60L 53/16; B60L 53/30; H02G 11/00

(52) U.S. Cl. CPC B60L 53/18; B60L 53/16; B60L 53/30; H02G 11/00

(57) ABSTRACT

A cable management system for an electric vehicle charger is designed to be coupled to a ceiling or wall of a structure such as a garage. For ceiling mounting, in some embodiments, the system can include a base, a support column extending downward from the base, and an arm rotatably coupled to the support column and extending horizontally or nearly horizontally outward from the base. For wall mounting, in some embodiments, the system can include a base with an arm rotatably coupled to the base and extending horizontally or nearly horizontally outward. Various embodiments feature components such as adjustable-length support columns, rotation restrictor mechanisms, charger mounts, motorized charge plug retractors, and overload protection mechanisms. In some embodiments, the system can be used with any electric vehicle charges because, for example, the charge cable can be routed along its structure without disconnecting it from the electric vehicle charger or charge plug.

### TECHNICAL FIELD

This relates to cable management systems for electric vehicle chargers and, in particular, to cable management systems mounted to the ceiling or wall of a garage or other structure.

### BACKGROUND

The popularity of electric vehicles has surged in recent years, largely due to their environmental benefits and advancements in battery technology. These vehicles depend on electric vehicle chargers to recharge their batteries. A typical electric vehicle charger includes a charger unit connected to a power source and a charge cable with a charge plug that fits into the vehicle's charge port. The charger unit converts alternating current (AC) from the power source into direct current (DC) suitable for the vehicle's battery.

Despite their critical role, managing the placement and charging cord of electric vehicle chargers poses several challenges. One common issue arises when a user purchases a replacement electric vehicle or adds a second one. The new or additional vehicle may have its charge port on the opposite side or a different location on the same side compared to the previous vehicle, necessitating either relocating the electric vehicle charger or unwinding lengthy charge cables to reach the new charge port, both of which can be inconvenient and impractical.

The placement of electric vehicle chargers is typically optimized for a single vehicle parked in a specific spot. This becomes problematic if a user parks in a different location or acquires a second vehicle. The electric vehicle charger may not be easily accessible for the new vehicle, and the charge cord might need to run behind another parked vehicle, obstructing access to the parking space of the parked vehicle. In some cases, the length of the charge cord may be insufficient to reach the new charge port, leading to the need for an additional electric vehicle charger, which increases cost and complexity.

A number of issues are also created when the charge cable extends across the ground to reach the electric vehicle. For example, the cable can become dirty and the dirt can be transferred to the user's hands or clothes, especially in winter conditions when the floor may be covered with melting snow, mud, and/or debris. Additionally, a charge cable on the floor poses a tripping hazard, raising the risk of accidents. Handling long lengths of charge cable is generally inconvenient, making the process of deploying and stowing the charge cable cumbersome for users.

These challenges highlight the need for improved solutions in managing the placement and charge cords of electric vehicle chargers.

### GENERAL DESCRIPTION

This describes various embodiments of a cable management system designed for use with electric vehicle chargers. It also describes electric vehicle charging systems that include the cable management system.

The cable management system is structured to be coupled to a ceiling or a wall of a structure, such as a garage, to manage the placement and handling of charge cables. The cable management system addresses many of the issues associated with traditional electric vehicle chargers, including charge cable placement, accessibility, and overall user convenience.

The cable management system can be used to enhance the functionality and convenience of the electric vehicle charger. For example, the cable management system enables streamlined usage scenarios, accommodating different vehicle charging port locations without the need to relocate the charger or endure cumbersome cable management tasks.

The following are some embodiments of a ceiling mounted cable management system that each include a base structured to be coupled to the ceiling of the structure, a support column coupled to the base and extending downward from the base, and an arm rotatably coupled to the support column and extending horizontally or approximately horizontally outward from the support column.

In some embodiments, the cable management system allows for the convenient routing of the charge cable along the support column and arm without disconnecting it from the electric vehicle charger or charge plug. For example, the cable management system can be structured for the charge cable to be coupled to the exterior of the various components and be configured to prevent the charge cable from being pinched or otherwise damaged as the arm rotates.

In some embodiments, the support column is slidingly coupled to the base. This arrangement offers flexibility for the base to be coupled to the studs or other supports in the ceiling and fix the support column at multiple locations along the length of the base. This makes it possible to position the support column at various locations to avoid various obstructions on the ceiling such as a garage door opener, garage door rails, lights, and the like. The sliding coupling arrangement can take various forms, such as a carriage that moves in a channel or the like.

In some embodiments, the arm of the cable management system includes a proximal beam and a distal beam that are rotatably coupled together. This dual-beam configuration allows the distal beam to rotate relative to the proximal beam, providing added flexibility in positioning the charge cable and charger plug, thereby accommodating different vehicle placements and charging port configurations.

In some embodiments, the arm of the cable management system is equipped with an overload protection mechanism. This mechanism includes a spring that holds the beam in a horizontal or approximately horizontal orientation. The spring can be configured to apply either a tension or compression force to the beam. The spring allows the beam to rotate downward when subjected to an unusual load, thus preventing damage to the system and/or the charging cable.

In some embodiments, the cable management system includes a charger mount that is coupled to the base or the support column, providing a dedicated mounting point for the electric vehicle charger. This configuration helps in organizing and securing the charger in a position close to the arm to thereby take advantage of the full length of the charge cable in configurations where the arm is long and positioned high above the floor.

In some embodiments, the length of the support column of the cable management system is adjustable. The length can be adjusted, for example, by configuring the support column to move telescopically. This enables users to modify the height of the arm so it is below various obstructions on the ceiling such as a garage door in an open position, a garage door opener, garage door hardware, lights, and the like.

In some embodiments, the cable management system includes a rotation restrictor mechanism structured to limit the rotation of the arm relative to the support column. The rotation restrictor mechanism can have a variety of configurations. For example, in one embodiment, it is covered to prevent the charge cable from being caught in it and damaged. In another embodiment, the rotation restrictor mechanism can be structured to allow more than 360 degrees of rotation of the arm relative to the support column.

In some embodiments, the cable management system includes a motorized retractor configured to move the charge plug from a lowered position to a raised position thereby facilitating easier handling of the charge plug and maintaining an organized appearance in the space.

The following are some embodiments of a wall mounted cable management system that each include a base structured to be coupled to the wall of the structure and an arm rotatably coupled to the base and extending horizontally or approximately horizontally outward from the wall. The wall mounted embodiments can include any of the features described in connection with the ceiling mounted embodiments unless specified otherwise.

In some embodiments, the wall-mounted cable management system includes a first fixed arm coupled to the base, a support column coupled to and extending vertically relative to the base, and a second arm rotatably coupled to the support column and extending outward horizontally or approximately horizontally. This setup offers the advantage of positioning the pivot point of the second arm further away from the wall and thereby providing additional flexibility and positioning options, making it easier to manage the charge cable and optimize electric vehicle charger placement.

The general description is provided to give a general introduction to the described subject matter as well as a synopsis of some of the technological improvements and/or advantages it provides. The general description and background are not intended to identify essential aspects of the described subject matter, nor should they be used to constrict or limit the scope of the claims. For example, the scope of the claims should not be limited based on whether the recited subject matter includes any or all aspects noted in the general description and/or addresses any of the issues noted in the background.

### DESCRIPTION OF DRAWINGS

The preferred and other embodiments are described in association with the accompanying drawings in which:

FIG. 1 is a perspective view of one embodiment of an electric vehicle charging system including an electric vehicle charger and a cable management system.

FIG. 2 is a perspective view from above of the cable management system in FIG. 1.

FIG. 3 is a perspective view from below of the cable management system in FIG. 1.

FIGS. 4-5 are perspective views of the base and support column of the cable management system in FIG. 1.

FIGS. 6-7 are exploded perspective views of the base and support column of the cable management system in FIG. 1.

FIG. 8 is a perspective view of one embodiment of a charge mount that can be used with the cable management system in FIG. 1.

FIG. 9 is side view of the charge mount in FIG. 8.

FIG. 10 is an exploded perspective view of the charge mount in FIG. 8.

FIG. 11 is a perspective view of another embodiment of the cable management system with a medium length support column and the charge mount coupled to the base.

FIGS. 12-13 are partially exploded perspective view of the cable management system in FIG. 11 showing the way the charge mount is coupled to the base.

FIG. 14 is a perspective view of another embodiment of the cable management system with a short support column and the charge mount coupled to the base.

FIGS. 15-16 are perspective views of one embodiment of a pivot mechanism that can be used to rotatably couple the distal beam of the arm to the proximal beam of the arm.

FIG. 17 is an exploded perspective view of the pivot mechanism in FIGS. 15-16.

FIG. 18 is a diagram showing the range of motion of the distal beam of the arm relative to the proximal beam using the pivot mechanism in FIGS. 15-17.

FIG. 19 is a perspective view of another embodiment of a pivot mechanism that can be used to rotatably couple the distal beam of the arm to the proximal beam of the arm.

FIG. 20 is a perspective view of another embodiment of a pivot mechanism having an offset axis that can be used to rotatably couple the distal beam of the arm to the proximal beam of the arm.

FIG. 21 is a diagram showing the range of motion of the distal beam of the arm relative to the proximal beam using the offset pivot mechanism in FIG. 20.

FIG. 22 is a perspective view of one embodiment of an extension beam that can be coupled to the distal end of the distal beam of the arm to extend its length.

FIG. 23 is an exploded perspective view of the extension beam in FIG. 22.

FIG. 24 is a perspective view from above of one embodiment of a pivot joint used to couple the arm to the support column in the cable management system in FIG. 1.

FIG. 25 is a perspective view from below of the pivot joint in FIG. 24.

FIGS. 26-27 are perspective views from above and below, respectively, of one embodiment of a rotation restrictor mechanism that can be used to restrict rotation of the arm of the cable management system in FIG. 1.

FIG. 28 is another embodiment of a rotation restrictor mechanism that can be used to restrict rotation of the arm of the cable management system in FIG. 1.

FIGS. 29-30 are perspective views from above and below, respectively, of one embodiment of an overload mechanism that can be used to allow the arm to rotate downward when subjected to an unusual or excessive force.

FIG. 31 is an exploded view of the overload mechanism in FIGS. 29-31.

FIGS. 32-35 show various cross-sectional views of the overload mechanism depicting how the proximal beam of the arm and the other components can rotate without binding.

FIGS. 36-37 are perspective views of the spring mechanism in the tension configuration with the outer tubing depicted as transparent.

FIG. 38 is a perspective view of the arm in an upper position and the overload mechanism in a compression configuration.

FIGS. 39-40 are perspective views from above and below, respectively, of the overload mechanism in FIG. 38.

FIG. 41 is an exploded view of the overload mechanism in FIG. 38.

FIG. 42 is a perspective view of the bottom of the overload mechanism in FIG. 38.

FIGS. 43-44 are perspective views of the spring mechanism in the compression configuration with the outer tubing depicted as transparent.

FIG. 45 is a perspective view of the arm with the overload mechanism removed to show the mounting holes in the proximal beam.

FIG. 46 is a perspective view of another embodiment of the arm without an overload mechanism.

FIGS. 47-49 are perspective views of a wall mount version of the cable management system.

FIG. 50 is a perspective view of one embodiment of the cable management system coupled to the ceiling of a garage.

FIG. 51 is a side view of one embodiment of the cable management system coupled to the ceiling of a garage.

FIG. 52 is a side view of one embodiment of a motorized cable management system coupled to the ceiling of a garage.

FIGS. 53-54 are plan views of one embodiment of motorized cable management system.

FIGS. 55-65 show various garage floorplan configurations illustrating the use of the cable management system.

FIG. 66 shows one embodiment of an electronic computing device that can used as part of the motorized cable management system.

FIG. 67 shows various embodiments of the devices that can be included as part of the electronic computing device in FIG. 66.

### DETAILED DESCRIPTION OF EMBODIMENTS

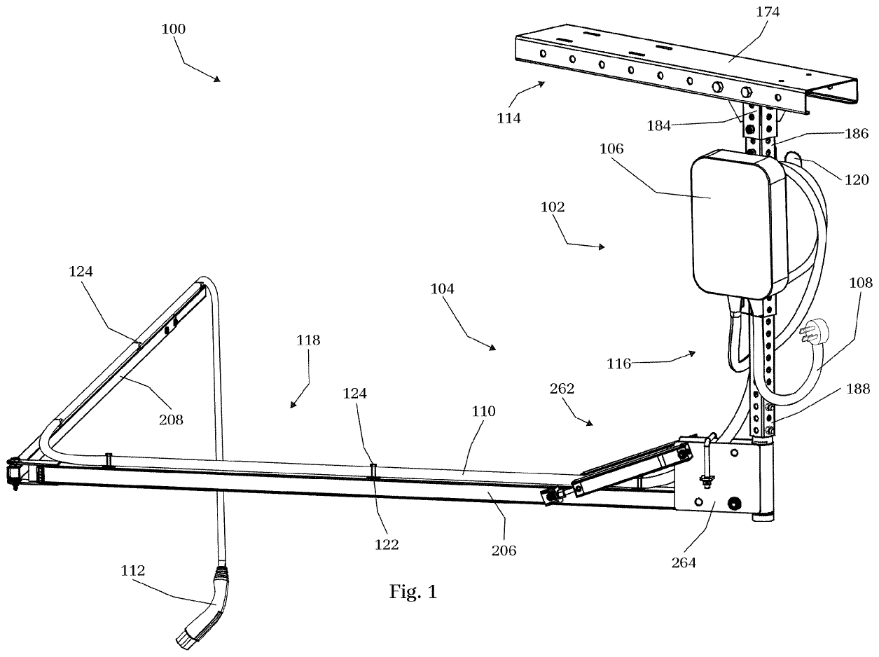

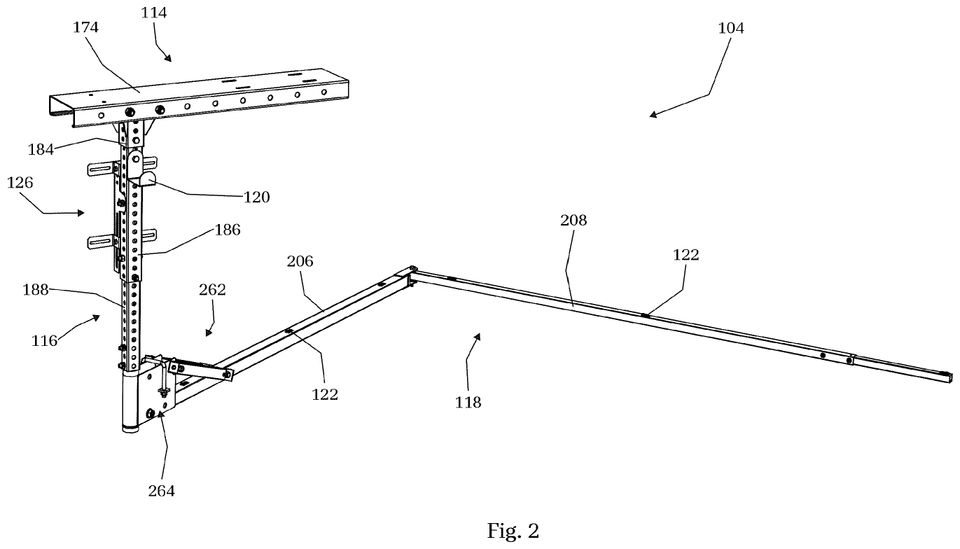

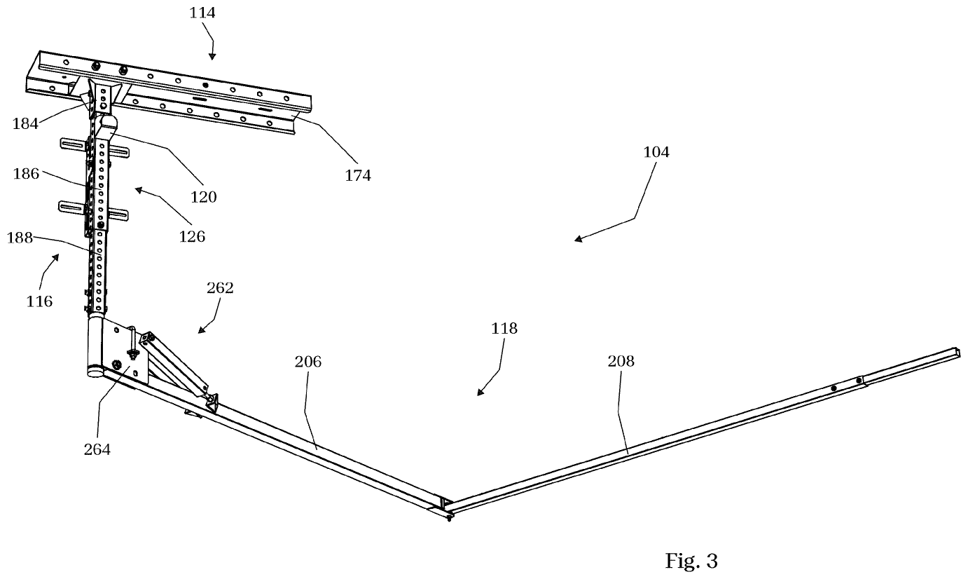

FIG. 1 is a perspective view of an electric vehicle charging system 100 comprising an electric vehicle charger 102 and a cable management system 104. The electric vehicle charging system 100 is structured to be coupled to the ceiling of a structure, such as a garage. FIGS. 2-3 are perspective views of the cable management system 104 from the top and the bottom, respectively.

The electric vehicle charger 102 comprises a charger unit 106 and a power cable 108 and a charge cable 110 both of which are coupled to the charger unit 106. The power cable 108 supplies power from the grid or other power source to the charger unit 106. The power cable 108 is shown as a plug that can be inserted into an electrical outlet. However, it should be appreciated that the power cable 108 can also be hardwired to an electrical system.

The charge cable 110 delivers power from the charger unit 106 to an electric vehicle through a charge plug 112 positioned at its distal end. The charge plug 112 is shown as a J1772 charge plug. However, the charge plug 112 can be any suitable plug such as NACS charge plug, CCS2 charge plug, or the like. The charge cable 110 can also have any suitable length. In some embodiments, the charge cable 110 is 15-26 ft long. For example, the charge cable 110 can be approximately 22-26 ft long.

It should be appreciated that the electric vehicle charger 102 can be any suitable electric vehicle charger. In some embodiments, the electric vehicle charger 102 is a level 1 (120V AC power source) or level 2 (240V AC power source) electric vehicle charger. The electric vehicle charger 102 can also be hardwired or connected to an outlet such as a 15 or 20 amp 120V outlet or a NEMA 6-50 or NEMA 14-50 outlet. The outlet can be in the ceiling or coupled to any of the components of the cable management system 104. For example, the outlet can be positioned in an electrical box coupled to any non-movable part of the cable management system 104 (the part does not move after the cable management system 104 is fully installed). The electrical box can be fastened to the cable management system 104 in any suitable manner and can be connected to the electrical system of the structure through wire that travels through flexible or rigid conduit from the electrical box to the ceiling.

### Cable Management System—Ceiling Mount

The cable management system 104 includes a base 114 (alternatively referred to as a mounting base, a mounting bracket, or a support base), a support column 116 (alternatively referred to as a column, a support pillar or pillar, a support post or post, a support strut or strut, a support upright or upright, a beam or vertical beam, or truss) coupled to and extending downward from the base 114, and an arm 118 (alternatively referred to as a boom, a beam, or a cantilever) coupled to and extending horizontally or approximately horizontally outward from the support column 116.

The electric vehicle charger 102 is coupled to the support column 116. The charge cable 110 extends from the bottom of the charger unit 106 to a charge cable holder 120, which is coupled to the opposite side of the support column 116 at approximately the same height as the charger unit 106. The charge cable 110 is wrapped around the charge cable holder 120 several times and routed downward along the support column 116, and outward along the length of the top of the arm 118. The charge cable 110 hangs downward from the distal end of the arm 118.

The charge cable 110 is coupled to the arm 118 with a series of cable ties 124 and cable tie holders 122. The cable tie holders 122 are coupled to and spaced along the length of the arm 118. Each cable tie holder 122 defines a hole or opening that is raised slightly from the top surface of the arm 118, creating a gap through which the cable tie 124 can be threaded.

The charge cable 110 is attached to the arm 118 by threading the cable tie 124 through the cable tie holder 122, looping it around the charge cable 110, and securing it to itself. This method not only holds the charge cable 110 securely but is also low cost and allows for quick and easy installation and replacement of cable ties 124 as necessary. The cable lies 124 securely hold the charge cable 110 to the arm 118 as it rotates.

It should be appreciated that the charge cable 110 can be coupled to the arm 118 in a variety of other ways. For example, the charge cable 110 can be coupled to the arm 118 with adjustable clamps, hook-and-loop fasteners, magnetic cable holders (e.g., magnetic cable tie holders), clips into which the charge cable 110 snaps, and adhesive-backed cable holders. In other embodiments, the arm 118 can include a channel on the top, side, or bottom sized to receive and hold the charge cable 110 either in a friction fit or with fasteners. For example, the arm 118 can be made of extruded metal with such a channel.

### Charger Mount

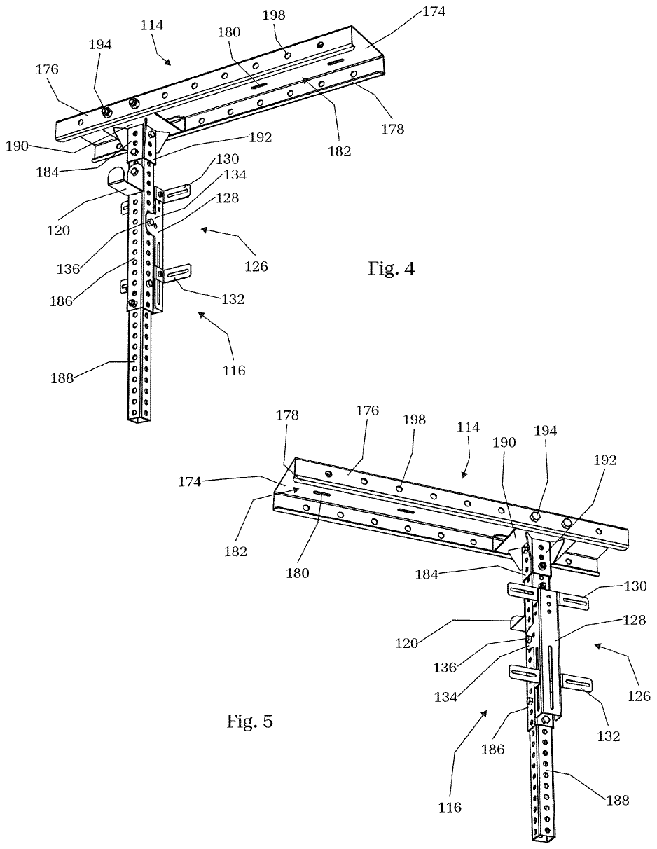

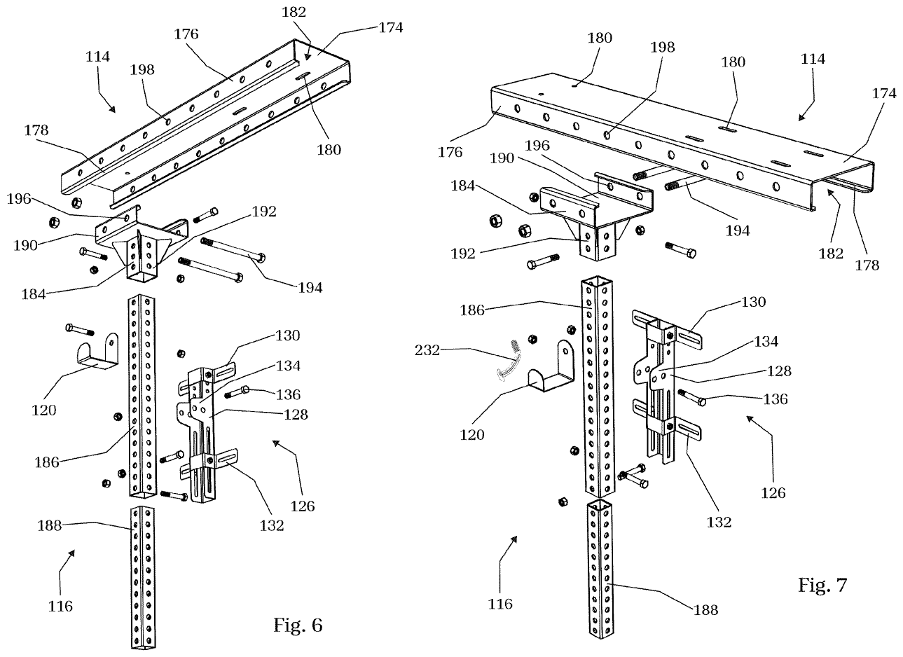

The charger unit 106 can be coupled to the support column 116 with a charger mount 126 (alternatively referred to as a charger holder or a charger bracket) as illustrated in FIGS. 4-10. The charger mount 126 is structured to accommodate the mounting requirements of off-the-shelf charger units 106 from a variety of electric vehicle charger manufacturers. For example, the charger mount 126 can be configured to work with electric vehicle chargers 102 manufactured by Tesla, ChargePoint, JuiceBox, Siemens, ClipperCreek, Grizzl-E, Bosch, Blink Charging, WallBox and the like. The charger mount 126 can also be configured to work with an electric vehicle charger 102 that is custom designed specifically for use with the cable management system 104.

In some embodiments, the charger mount 126 is versatile and can accommodate the unique mounting configurations and fastener location requirements of a variety of different models and brands of electric vehicle chargers 102. The versatility of the charger mount 126 makes the cable management system 104 especially suitable for use with any off-the-shelf electric vehicle charger 102. It also makes it easy for users to switch electric vehicle chargers if needed.

It should be appreciated that the cable management system 104 can be used without the charger mount 126. For example, the electric vehicle charger 102 can be coupled directly to the ceiling of the structure near the cable management system 104. The charger mount 126 provides some advantages over directly mounting the electric vehicle charger 102 to the structure. For example, the charger mount 126 makes it much easier to mount the electric vehicle charger 102 and makes it possible to mount it closer to the arm 118, which maximizes the length of the charge cable 110 that can be routed along the arm 118 and down to the electric vehicle.

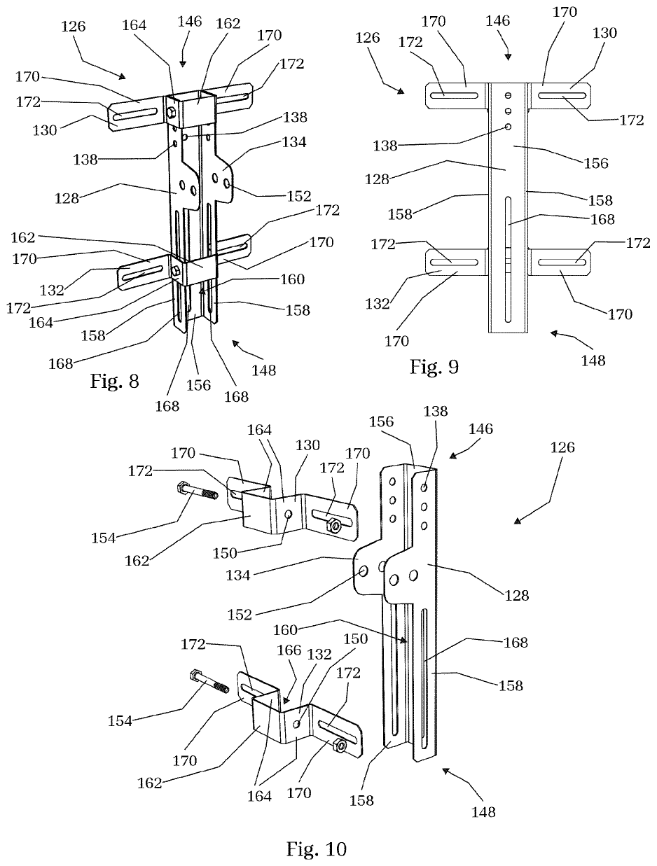

Referring to FIGS. 8-10, the charger mount 126 includes a first mount rail 128, a second mount rail 130 coupled to the first mount rail 128, and a third mount rail 132 coupled to the first mount rail 128. The second mount rail 130 is coupled to the first mount rail 128 at or near a first end 146 of the first mount rail 128, and the third mount rail 132 is coupled to the first mount rail 128 at or near a second end 148 of the first mount rail 128. The second mount rail 130 and the third mount rail 132 are both positioned transverse or crosswise to a lengthwise direction of the first mount rail 128. Additionally, the second mount rail 130 and the third mount rail 132 can be structurally similar or identical.

The first mount rail 128 includes a base 156 and sidewalls 158 extending outward from the base 156 and forming a U-shaped channel 160. The sidewalls 158 each include a tab 134 where the sidewall 158 juts further outward than the remaining sidewall 158. Each tab 134 includes a hole 152, which serves as an attachment point for fastening the first mount rail 128 to the support column 116 with a fastener 136. In some embodiments, the fastener 136 can be a quick-release fastener, such as a quick-release pin with a spring-loaded ball on one end, a wire lock pin, or the like, to make it easy for the user to couple the charger mount 126 to the support column 116.

The first mount rail 128 also includes a series of spaced-apart holes 138 located in the base 156 and the sidewalls 158 between the tabs 134 and the first end 146 and slots 168 located in the base 156 and sidewalls 158 between the tabs 134 and the second end 148. The holes 138 and slot 168 in the base 156 are used to couple the first mount rail 128 to the charger unit 106. The holes 138 and slots 168 in the sidewalls 158 are used to couple the first mount rail 128 to the second mount rail 130 and the third mount rail 132.

The second mount rail 130 and the third mount rail 132 also include a base 162, sidewalls 164 extending outward from the base 162 and forming a U-shaped channel 166, and wing mount surfaces 170 extending outward from the sidewalls 164. The sidewalls 164 each include a hole 150 that is positioned to align with the holes 138 or the slots 168 in the sidewalls 158 of the first mount rail 128. The wing mount surfaces 170 includes slots 172 that are used to couple the second mount rail 130 and the third mount rail 132 to the charger unit 106. The U-shaped channels 166 of the second mount rail 130 and third mount rail 132 are designed to fit snugly over the sidewalls 158 of the first mount rail 128 in the manner shown in FIGS. 8-10.

The second mount rail 130 and third mount rail 132 can be secured to the first mount rail 128 by aligning the holes 150 with the holes 138 or the slots 168 and inserting a fastener 154. In some embodiments, the fastener 154 may be a quick-release type fastener similar to the fastener 136 used with the first mount rail 128. The configuration of the mount rails 128, 130, 132 allows the second mount rail 130 and the third mount rail 132 to be slidingly coupled to the first mount rail 128 at a variety of positions along its length.

As mentioned above, the charger unit 106 can have a variety of mounting configurations, especially the charger units for level 2 electrical vehicle chargers that are typically configured to be mounted to a wall. The charger units 106 can include mounting brackets or holes on their back surfaces or edges intended for securing the unit to the wall with screws or other fasteners. The configurations and spacing of these holes and fasteners can vary widely between different models of electric vehicle chargers.

For example, some common examples of these mounting configurations include: (i) two fasteners aligned vertically and configured to be fastened to a vertical stud in a wall, (ii) two fasteners aligned horizontally, (iii) two fasteners not aligned vertically or horizontally, (iii) three fasteners arranged in a line or in the shape of a triangle, (iv) four fasteners arranged in an upright or inverted T-shape, (v) four fasteners arranged in the shape of a rectangle or square.

The charger mount 126 can be adjusted to accommodate these various fastener configurations. It should be noted that the second mount rail 130 and the third mount rail 132 may not be needed depending on the fastener configuration. For example, the first mount rail 128 can be used alone for those configurations where the fasteners are in a line. In such a case, the charger unit 106 can be coupled to the charger mount 126 with one fastener positioned in one of the holes 138 in the base 156 of the first mount rail 128 and another fastener positioned in the slot 168. The location and spacing of the holes 138 and the slot 168 make it possible to accommodate closely spaced and distant fastener configurations.

The second mount rail 130 can also be used for those configurations where the fasteners are in a line. In this case, the fasteners can be coupled to the slots 172 on the wing mount surfaces 170 and/or through one of the holes 138 in the base 156 of the first mount rail 128.

The first mount rail 128 and the third mount rail 132 can be used for those situations where the charger unit 106 has fasteners arranged in the shape of a triangle. In this situation, the second mount rail 130 is not used. The fastener at the top of the triangle shape can pass through one of the holes 138 in the base 156 of the first mount rail 128 and the fasteners at the bottom corners of the triangle shape can pass through the slots 172 on each of the wing mount surface 170 of the third mount rail 132.

All three of the mount rails 128, 130, 132 can be used for those situations where the charger unit 106 has fasteners arranged in the shape of a rectangle. In this situation, the fasteners at each corner of the rectangle pass through a corresponding slot 172 on each of the wing mount surfaces 170 of the second mount rail 130 and the third mount rail 132.

The variety of holes and slots in the mount rails 128, 130, 132 combined with the ability to slidingly couple the second mount rail 130 and/or the third mount rail 132 to various locations along the first mount rail 128 makes it possible to create a wide variety of configurations to which any or almost any charger unit 106 can be coupled.

The configuration of the mount rails 128, 130, 132 also makes it easy to couple the charger unit 106 to the charger mount 126. For example, in some embodiments, the charger unit 106 can be coupled to the charger mount 126 in the following manner. The first step is to position the base 156 of the first mount rail 128 against the back of the charger unit 106 and couple the first mount rail 128 and the charger unit 106 together with any fastener or fasteners that align with one or more of the holes 138 or the slot 168. If the fastener configuration is such that no fasteners will pass through the holes 138 or the slot 168, then the base 156 of the first mount rail 128 is simply placed on the back of the charger unit 106. If the fastener configuration is such that the fasteners will only pass through the holes 138 and/or slot 168 and the mount rails 130, 132 are not needed, then the process is complete and the charger mount 126 can be coupled to the cable management system 104.

Assuming the process is not complete, the next step is position one or both of the second mount rail 130 and/or the third mount rail 132 over the first mount rail 128 so that the wing mount surfaces 170 contact the back of the charger unit 106. The mount rails 130, 132 are moved lengthwise along the first mount rail 128 until the slots 172 are aligned with the fastener locations on the charger unit 106, and the mount rails 130, 132 are fastened securely to the charger unit 106.

The next step is to slide the first mount rail 128 relative to the second mount rail 130 and/or third mount rail 132 until the holes 150 in the sidewalls 164 of the mount rails 130, 132 are aligned with the holes 138 or slots 168 in the sidewalls 158 of the first mount rail 128. At this point, the fasteners 154 are inserted through the relevant holes 150, 138 and/or slots 168 to securely couple the mount rails 128, 130, 132 together.

The final step is to securely couple the assembly formed by the charger mount 126 and the charger unit 106 to the cable management system 104 using the fastener 136 in the manner described above. The advantage of this process is that the user can perform the initial steps at ground level where it is much easier to access and handle the charger unit 106 and the charger mount 126. It is only at the final step when the user needs to climb a ladder and, even then, it's just to insert a single fastener 136, which can be a quick release fastener.

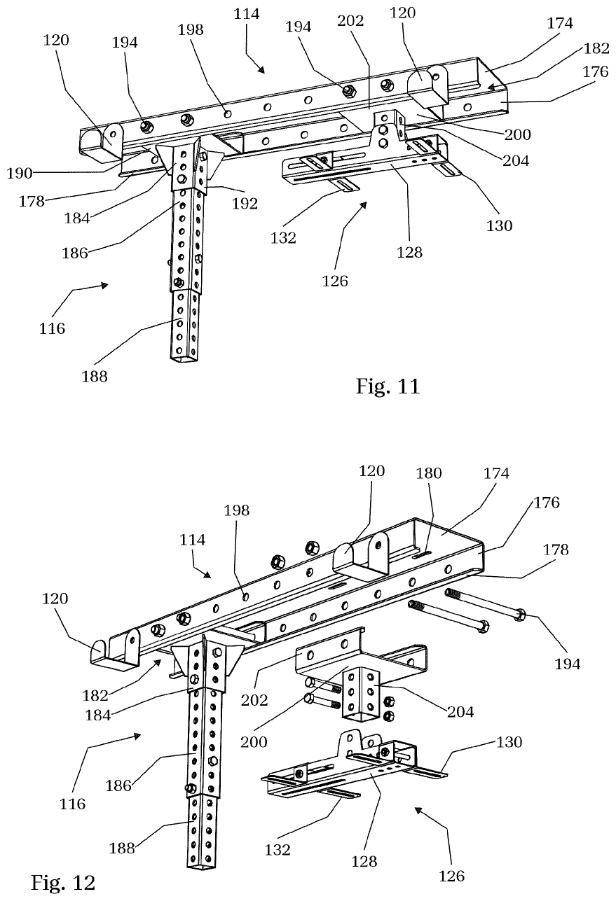

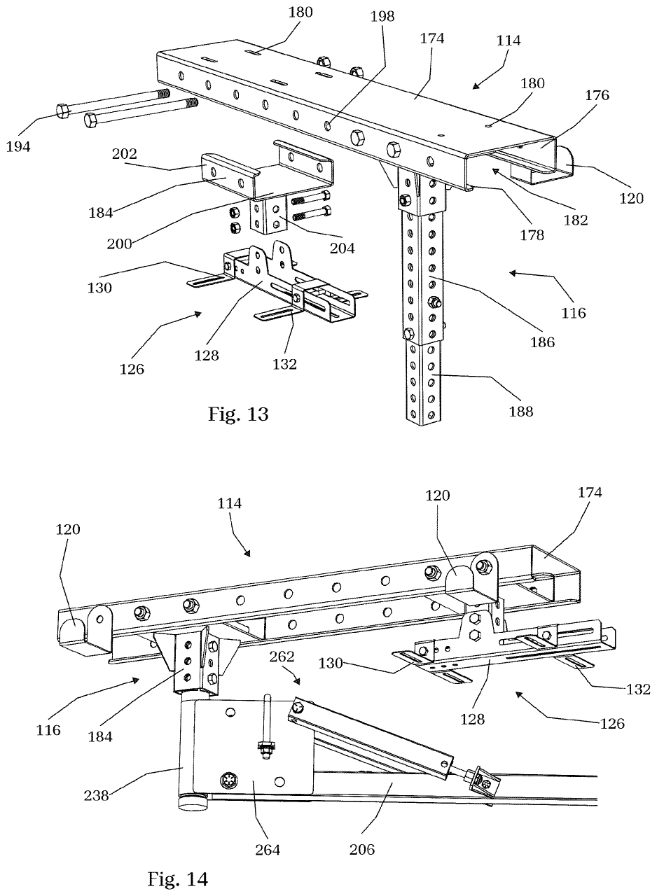

Referring to FIGS. 11-14, the charger mount 126 can also be coupled to the base 114 via a sliding mount 200 that is similar in structure and function to the sliding mount 184 used to couple the support column 116 to the base 114. The sliding mount 200 can include a carriage 202 and a body 204 coupled to and extending outward from the carriage 202 in a manner similar to the carriage 190 and the body 192 of the sliding mount 184. The carriage 202 of the sliding mount 200 is sized and shaped to fit within and slide along the channel 182 in the base 114.

Coupling the charger mount 126 to the base 114 with the sliding mount 200 provides additional flexibility in positioning the electric vehicle charger 102 relative to the support column 116 and the arm 118. The user can slide the charger mount 126 along the channel 182 in the base 114 to various positions, allowing the charger unit 106 to be mounted closer to or farther away from the support column 116, the arm 118, and/or other obstructions on the ceiling of the structure. The sliding mount 200 also makes it possible to position the charger unit 106 flat near the ceiling, which conserves the use of space in low head room situations.

For example, in some installations, it may be desirable to mount the charger unit 106 near the proximal end of the arm 118 to minimize the distance the charge cable 110 needs to extend from the charger unit 106 to the arm 118. In this case, the sliding mount 200 can be positioned along the base 114 so that the charger mount 126 and charger unit 106 are adjacent to the support column 116. In other installations, it may be preferable to mount the charger unit 106 farther away from the proximal end of the arm 118, such as when there are other obstructions on the ceiling near the support column 116. The sliding mount 200 allows the charger unit 106 to be positioned at various locations offset from the support column 116 as needed.

The sliding mount 200 can be securely fastened to the base 114 in the same manner the sliding mount 184 is coupled to the base 114. For example, the sliding mount 200 can be fastened to the base 114 by inserting the fasteners 194 through holes in the sidewalls of the carriage 202 that align with the holes 198 in the sidewalls 176 of the base 114.

### Charge Cable Holder

The charge cable holder 120 is used to effectively manage and hold any extra length of the charge cable 110. It is shaped and positioned to securely accommodate the additional length of the charge cable 110 and thereby hold it in a location that keeps it from interfering with other components or the overall operation of the cable management system 104, particularly the rotation of the arm 118.

The charge cable holder 120 can have any suitable shape and/or configuration. In some embodiments, the charge cable holder 120 has a hook shape, which is configured to hold one or more windings of the charge cable 110. This configuration allows the charge cable 110 to be looped over the charge cable holder 120 in a manner that keeps it organized. The charge cable holder 120 can also be coupled to various locations on the cable management system 104 and/or the ceiling of the structure. For example, the charge cable holder 120 can be attached to the base 114 or the support column 116, as depicted in FIGS. 1-7 and 11-12.

The position and configuration of the charge cable holder 120 can be influenced by the amount of available head space within the structure. In a garage, the head space refers to the distance from the top of the garage door opening to the ceiling, whereas in other structures, it is the distance from the lowest ceiling obstruction that the arm 118 needs to clear to the ceiling. In structures with ample head space, the charge cable holder 120 can be mounted to the support column 116 in the manner shown in FIG. 1, allowing the charge cable 110 to be looped over and hang down from the charge cable holder 120.

In structures where the head space is limited, the charge cable holder 120 can be positioned differently to accommodate the spatial constraints. For example, it can be coupled to the base 114, thereby moving the extra loops of the charge cable 110 closer to the ceiling. In scenarios with restricted head space, two charge cable holders 120 can be coupled to the base 114 in a spaced-apart configuration, as shown in FIG. 14. This setup allows for the extra charge cable 110 to be tightly wrapped around the two charge cable holders 120 and thereby holding the extra charge cable 110 even closer to the ceiling.

The charge cable holder 120 can be fastened to the base 114 or the support column 116 using various fasteners or fastening methods, depending on factors such as the design of the charge cable holder 120, the material of the base 114 or support column 116, the desired strength and durability of the attachment, and the ease of installation or removal.

In some embodiments, the charge cable holder 120 is fastened to the base 114 or the support column 116 using a corner bolt 232 (FIG. 7). The corner bolt 232 is an L-shaped fastener structured to join two perpendicular surfaces or components. To attach the charge cable holder 120 to the base 114 or the support column 116 using the corner bolt 232, the corner bolt 232 is first positioned so that one leg extends through a hole or slot in the base 114 or the support column 116 and the other leg extends along a perpendicular side of the base 114 or the support column 116. The charge cable holder 120 is then aligned with the leg of the corner bolt 232 that extends along the perpendicular side of the base 114 or the support column 116. A nut is then threaded onto the end of the corner bolt 232 and tightened to securely hold the charge cable holder 120 in place.

The corner bolt 232 is particularly advantageous for coupling the charge cable holder 120 to the base 114 or the support column 116 when the surface opposite the mounting location is covered by another component, such as the charger mount 126, but a perpendicular side surface is accessible. In this situation, the corner bolt 232 allows the charge cable holder 120 to be securely attached to the base 114 or the support column 116 without interfering with the other component.

For example, in the embodiment shown in FIG. 7, the charger mount 126 is attached to one side of the support column 116, covering the surface that would typically be used to attach the charge cable holder 120. However, by using the corner bolt 232, the charge cable holder 120 can be attached to the opposite side of the support column 116, providing a secure and convenient mounting point for the charge cable holder 120 without interfering with the charger mount 126.

It should be noted that while the corner bolt 232 is a suitable fastener for attaching the charge cable holder 120 to the base 114 or the support column 116 in many situations, other fasteners or fastening methods can also be used.

### Base

Referring to FIGS. 1-14, the base 114 includes a main or base wall 174, sidewalls 176 extending downward from the base wall 174, and flanges 178 extending inward from the sidewalls 176 towards each other. The base wall 174 is configured to be positioned against and coupled to the ceiling of the structure with fasteners that extend through mounting holes 180.

The base 114 also includes a channel 182 that is configured to slidingly receive a portion of the support column 116. The channel 182 is defined by the inner surfaces of the base wall 174, the sidewalls 176, and the flanges 178. The channel 182 has a uniform cross-sectional shape that extends along its length. In the illustrated embodiment, the channel 182 has a C-shaped cross-sectional shape, although other cross-sectional shapes are possible such as V-shaped or the like.

The base 114 is configured to be coupled to a variety of structures and materials such as those commonly found in garage ceilings, including wood ceiling joists or trusses, steel trusses, concrete, and the like. The mounting holes 180 are spaced apart in manner that allows the base 114 to be coupled to surfaces with varying joist or truss spacing.

For example, in some embodiments, the base 114 includes three sets of the mounting holes 180 arranged so that two of the sets of mounting holes 180 are spaced apart approximately 12 in, two of the sets of the mounting holes 180 are spaced apart approximately 16 in, and two of the sets of the mounting holes 180 are spaced apart approximately 24 in. This configuration makes it so the base 114 can be coupled to surfaces with joist or stud spacings of approximately 12 in, approximately 16 in, or approximately 24 in.

In some embodiments, the mounting holes 180 are elongated to accommodate joists or studs that are not exactly spaced 12 in, 16 in, or 24 in apart. For example, the mounting holes 180 can be elongated slots that are 0.75-2 in long in a lengthwise direction of the base 114. The elongated mounting holes 180 provide some adjustability in the positioning of the base 114 relative to the joists or studs.

It should be appreciated that the base 114 can have any suitable size, shape, or configuration. For example, the channel 182 can have any suitable cross-sectional shape such as square, circular, oval, polygonal, or the like. The base 114 can also be any suitable length. For example, the length of the base 114 can be approximately 14-28 in or more. In some embodiments, the base 114 is a little more than 2 ft long—e.g., 28 in. The base 114 can also be made of any suitable material that is strong enough to support the cable management system 104. Preferably, the base 114 is made of metal such as carbon steel, stainless steel, aluminum, or the like.

### Support Column

With continued reference to FIGS. 1-14, the support column 116 includes a sliding mount 184, a proximal or first extension 186 coupled to and extending downward from the sliding mount 184, and a distal or second extension 188 coupled to and extending downward from the proximal extension 186. The sliding mount 184 can include a carriage 190 (alternatively referred to as a main body or slider) and a body 192 coupled to and extending outward from the carriage 190. For example, the body 192 can be welded or otherwise permanently fastened to the carriage 190.

In some embodiments, the carriage 190 has a uniform cross-sectional shape that is complementary to the cross-sectional shape of the channel 182 in the base 114. For example, the carriage 190 can have a C-shaped cross-sectional shape that is complementary to the C-shaped cross-sectional shape of the channel 182. The carriage 190 can also include a main or base wall, sidewalls extending upward from the base wall, and flanges extending inward from the sidewalls towards each other in a manner that is similar to the base 114.

The support column 116 is coupled to and extends downward from the base 114. In some embodiments, the support column 116 can be slidingly coupled to the base 114 in a manner that allows the position of the support column 116 to be adjusted by sliding the support column 116 along the length of the channel 182 in the base 114. For example, the carriage 190 can be sized and shaped to fit in the channel 182 in a manner that allows the carriage 190 to slide along the channel 182.

The ability to slide the support column 116 relative to the base 114 provides flexibility in the placement of the support column 116. This is particularly advantageous in settings where there may be other structures mounted to the ceiling such as a garage door opener, garage door track, lighting fixtures, or the like. The sliding coupling between the support column 116 and the base 114 allows the support column 116 to be positioned to avoid interference with these structures.

For example, in some embodiments, the user can slide the support column 116 along the length of the base 114 to a position between adjacent garage door tracks. Alternatively, the user can slide the support column 116 to a position on either side of a garage door opener. The sliding coupling between the support column 116 and the base 114 provides installers with more options for positioning the support column 116, which makes the cable management system 104 easier to install in a wider variety of garage configurations.

Once the support column 116 is in position, it can be securely fastened to the base 114 with fasteners 194 that extend through holes 196 in the sidewalls of the carriage 190 and corresponding holes 198 in the base 114. The holes 198 in the base 114 are arranged in a repeating pattern along the length of the base 114 so the support column 116 can be fixed to the base 114 at multiple locations along the length of the base 114.

In some embodiments, the length of the support column 116 is adjustable. For example, the sliding mount 184, the proximal extension 186, and/or the distal extension 188 can all be coupled together in a telescoping manner. For example, the body 192, the proximal extension 186, and the distal extension 188 can all be tubes or have tubular shapes that allow them to telescope relative to each other. The tubes can have regularly spaced holes in them—e.g., holes every 1-2 in. The holes in the proximal extension 186 and the distal extension 188 can be selectively aligned and a fastener inserted through the aligned holes to fix the length of the support column 116.

FIGS. 1-7 show one embodiment of the cable management system 104 having a relatively long support column 116. This embodiment is suitable for situations where the structure has no shortage of head space. FIGS. 11-13 show another embodiment of the cable management system 104 having an intermediate length support column 116. This embodiment is suitable for situations where the structure has less head space. FIG. 14 shows another embodiment of the cable management system 104 having a short support column 116. In this embodiment, the tubes for the body 192, the proximal extension 186, and the distal extension 188 are the same length and nested inside each other.

It should be appreciated that the body 192, the proximal extension 186, and the distal extension 188 of the support column 116 can be made of any suitable material that provides the desired strength, durability, and aesthetic properties. In some embodiments, these components are made of metal tubing, such as steel (e.g., mild steel or stainless steel), aluminum, or the like. The metal tubing can have various cross-sectional shapes, including square, rectangular, or round.

In the embodiment shown in FIGS. 1-7, the body 192, the proximal extension 186, and the distal extension 188 are made of perforated square metal tubing. Perforated tubing has holes or slots punched along its length, which can serve several purposes. First, the perforations can reduce the overall weight of the tubing while maintaining its strength and rigidity. This is particularly advantageous for the support column 116, as it helps to minimize the load on the base 114 and the ceiling of the structure to which the cable management system 104 is attached.

Second, the perforations can facilitate the attachment of accessories or other components to the support column 116. For example, the charge cable holder 120 as well as other hooks, brackets, or cable ties can be easily attached to the perforated tubing to help manage the charge cable 110 or to add other functionality to the cable management system 104.

Although perforated square metal tubing is shown in the embodiment of FIGS. 1-7, it should be noted that the body 192, the proximal extension 186, and the distal extension 188 of the support column 116 can be made of any suitable material and can have any suitable cross-sectional shape. For example, these components can be made of solid (non-perforated) metal tubing, round metal tubing, or tubing made of other materials such as plastic or composite materials.

### Arm

Referring to FIGS. 1-3, the arm 118 is rotatably coupled to the support column 116 and extends horizontally or approximately horizontally outward from the support column 116. The arm 118 includes a proximal beam 206 (alternatively referred to as a proximal section, first beam, or first section) and a distal beam 208 (alternatively referred to as a distal section, second beam, or second section). The proximal beam 206 is rotatably coupled to the support column 116, and the distal beam 208 is rotatably coupled to the proximal beam 206.

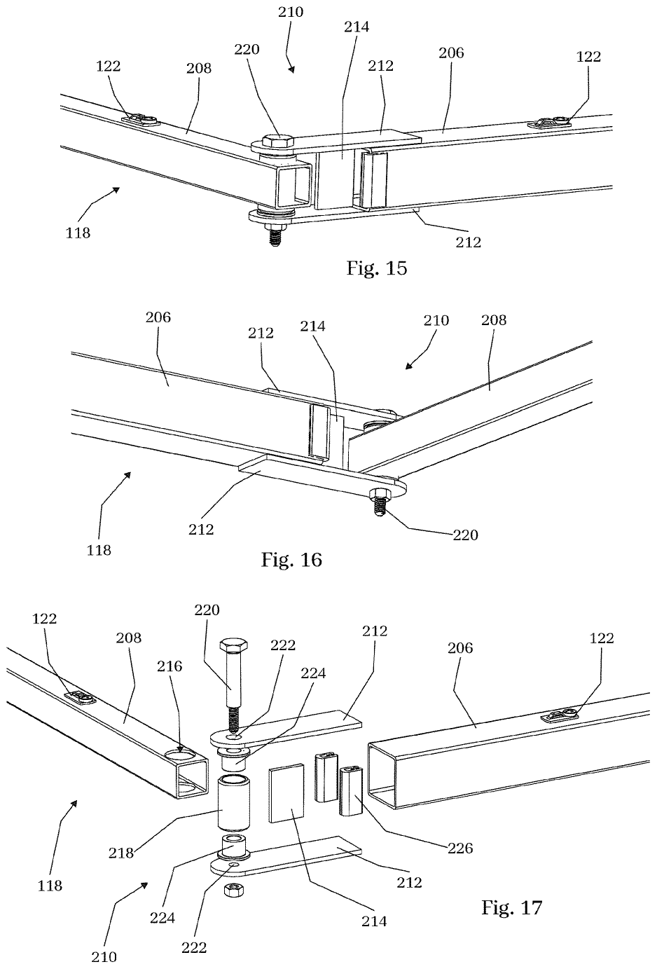

Referring to FIGS. 15-17, the proximal beam 206 and the distal beam 208 can be rotatably coupled together with the pivot mechanism 210. The pivot mechanism 210 includes top and bottom support plates 212 fastened to the top and bottom surfaces of the proximal beam 206, such as by welding. The support plates 212 extend outward from the distal end of the proximal beam 206 in a cantilevered manner. A brace 214 is positioned between the cantilevered portions of the support plates 212 to hold them in a spaced apparat orientation.

The proximal end of the distal beam 208 includes a hole 216 in which a pivot sleeve 218 is fastened, such as by welding. The pivot sleeve 218 is positioned between the cantilevered portions of the support plates 212. Bushings 224 are inserted into the ends of the pivot sleeve 218. The proximal end of the distal beam 208 is positioned between the support plates and the hole in the pivot sleeve 218 is aligned with holes 222 in the support plates 212. A pivot shaft or bolt 220 extends through the holes 222 in the support plates 212, the bushings 224, and the hole through the pivot sleeve 218. The bushings 224 facilitate smooth rotation of the pivot shaft 220 relative to the support plates 212.

The pivot shaft 220 defines a pivot axis about which the distal beam 208 rotates relative to the proximal beam 206. The pivot axis is centered relative to the proximal beam 206 and the distal beam 208. This allows the distal beam 208 to rotate to either side of a lengthwise axis defined by the proximal beam 206.

Bumpers 226 are coupled to the distal end of the vertical walls of the proximal beam 206 on opposite sides of the pivot sleeve 218. The bumpers 226 are positioned to be contacted by the distal beam 208 when it is rotated toward the proximal beam 206. The bumpers 226 prevent the distal beam 208 from directly contacting the proximal beam 206, which could damage the beams 206, 208. The bumpers 226 can be made of any suitable material such as rubber, plastic, or the like.

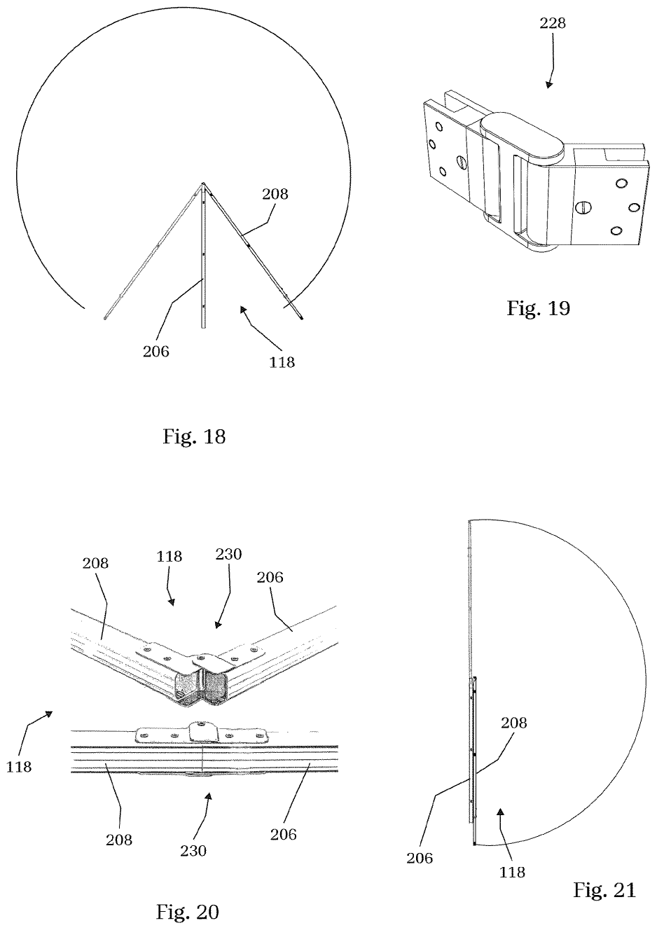

The pivot mechanism 210 advantageously allows the distal beam 208 to pivot relative to the proximal beam 206 in the manner shown in FIG. 18. This provides additional flexibility in positioning the charge plug 112 relative to the electric vehicle. For example, if the electric vehicle is parked such that its charge port is not positioned directly below the overall radius of rotation of the arm 118, the distal beam 208 can be pivoted toward the proximal beam 206 to move the charge plug 112 into alignment with the charge port.

The proximal beam 206 and the distal beam 208 can be rotatably coupled together in a variety of ways using any suitable pivot mechanism. In addition to the pivot mechanism 210 described above, the proximal beam 206 and the distal beam 208 can be coupled together using an articulated pivot mechanism 228, as shown in FIG. 19. The articulated pivot mechanism 228 includes two pivot axes about which the distal beam 208 can rotate relative to the proximal beam 206.

The two pivot axes of the articulated pivot mechanism 228 allow the distal beam 208 to rotate between a first position where it is positioned parallel to and adjacent one side of the proximal beam 206 and a second position where it is positioned parallel to and adjacent the opposite side of the proximal beam 206. This range of rotation is greater than that provided by the pivot mechanism 210.

As shown in FIG. 18, the pivot mechanism 210 allows the distal beam 208 to rotate more than 270 degrees relative to the proximal beam 206. However, the articulated pivot mechanism 228 allows the distal beam 208 to rotate 360 degrees or nearly 360 degrees relative to the proximal beam 206. The greater range of rotation provided by the articulated pivot mechanism 228 offers additional flexibility in positioning the distal end of the arm 118 and the charge plug 112 relative to the electric vehicle. The downside of the articulated pivot mechanism 228 is that the use of two pivot axes increases the amount of play, which can cause the distal beam 208 to sag.

The proximal beam 206 and the distal beam 208 can also be rotatably coupled together using an offset pivot mechanism 230, as shown in FIG. 20. The offset pivot mechanism 230 includes a pivot axis that is offset to the side of the proximal beam 206. As shown in FIG. 21, the offset pivot axis allows the distal beam 208 to rotate between a first position where it extends straight out from the distal end of the proximal beam 206 and a second position where it is positioned parallel to and adjacent one side of the proximal beam 206.

In some embodiments, the proximal beam 206 and the distal beam 208 lie in approximately the same horizontal plane as illustrated in FIGS. 1-3. This configuration is advantageous because it reduces the vertical profile of the arm 118 so it can be positioned as close to the ceiling as possible.

The proximal beam 206 and the distal beam 208 can be any suitable size and have any suitable configuration. For example, in some embodiments, the proximal beam 206 and the distal beam 208 can be made from the same material and have the same characteristics. In other embodiments, the proximal beam 206 can be larger than the distal beam 208. For example, the proximal beam 206 can have a larger cross-sectional area, diameter, and/or wall thickness than the distal beam 208. The larger size of the proximal beam 206 increases its strength and rigidity, which is advantageous because it is coupled to and supports the distal beam 208. The smaller size of the distal beam 208 decreases its weight, which reduces the load on the proximal beam 206 and thereby reduces overall deflection of the arm 118.

The proximal beam 206 and the distal beam 208 can be made of any suitable material that provides the desired strength, durability, and weight characteristics. In some embodiments, the proximal beam 206 and the distal beam 208 are made of metal, such as steel (e.g., mild steel or stainless steel), aluminum, or the like. The metal can be in the form of square tubing, round tubing, or tubing with any other suitable cross-sectional shape including custom extruded profiles.

Square metal tubing is advantageous because it has a high strength-to-weight ratio and can be easily connected to other components, such as pivot mechanisms, using conventional fasteners or welding techniques. Square tubing also has a neat, clean appearance that can enhance the overall aesthetics of the cable management system 104. Round metal tubing is also advantageous because it has a high strength-to-weight ratio and a sleek, modern appearance. Round tubing can also be easily connected to other components using conventional fasteners or welding techniques.

The proximal beam 206 and the distal beam 208 can each have any suitable length. In some embodiments, the length of the proximal beam 206 is approximately 1-8 ft and the length of the distal beam 208 is approximately 1-8 ft. The proximal beam 206 and the distal beam 208 can have approximately the same lengths or different lengths. The length of the arm 118 corresponds to the combined lengths of the proximal beam 206 and the distal beam 208. In some embodiments, the length of the arm 118 is approximately 2-12 ft.

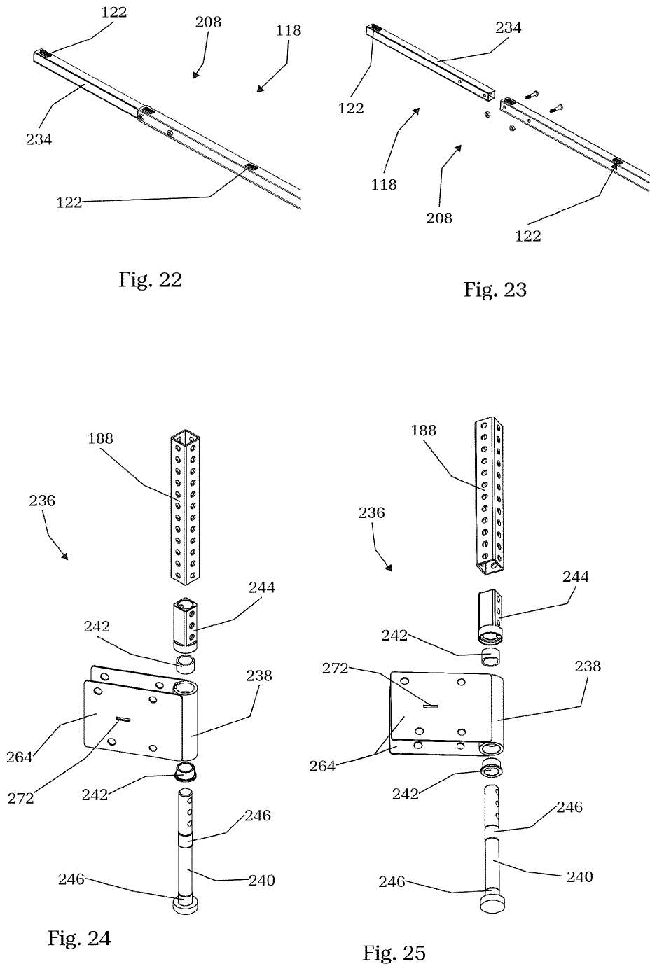

Referring to FIGS. 22-23, in some embodiments, the distal beam 208 can include an optional beam extension 234 to provide additional reach and flexibility in positioning the charge plug 112 relative to the electric vehicle. The beam extension 234 is telescopically coupled to the distal end of the distal beam 208, allowing it to extend and retract as needed.

In some embodiments, the beam extension 234 is a length of tubing or other suitable material that is sized to fit inside the distal end of the distal beam 208. The beam extension 234 can be made of the same material as the distal beam 208 or a different material, depending on the desired strength, weight, and durability characteristics.

The beam extension 234 can be extended or retracted to adjust the overall length of the distal beam 208. In some embodiments, the beam extension 234 can extend the length of the distal beam 208 by approximately 6 inches to 3 feet. This adjustability allows the cable management system 104 to accommodate a wider range of electric vehicle parking positions and charge port locations.

To secure the beam extension 234 at the desired length, various fasteners can be used. For example, the beam extension 234 and the distal beam 208 can include a series of aligned holes that allow a pin, bolt, or other fastener to be inserted through the holes to hold the beam extension 234 in place.

The beam extension 234 can be particularly useful in situations where the garage door is especially tall or wide and/or the electric vehicle is parked further away from the support column 116 than the standard length of the arm 118 can accommodate. By extending the beam extension 234, the charge plug 112 can be positioned closer to the electric vehicle's charge port, making it easier for the user to plug in the vehicle.

It should be appreciated that the arm 118 can have a variety of configurations. For example, in some embodiments, the arm 118 is formed as a single beam rather than a proximal beam 206 and a distal beam 208 that are rotatably coupled together. The single beam can extend from the support column 116 to the distal end of the arm 118 without any rotatable couplings along its length. Although a single beam may be simpler and more cost-effective design compared to the two beam configuration, it has the disadvantage of not allowing the distal end of the arm 118 to be rotated toward the proximal end of the arm 118, which can make it more difficult to align the charger plug 112 with the charge port of the electric vehicle in many situations.

The arm 118 is rotatably coupled to the support column 116 with a pivot joint 236. The pivot joint 236 allows the arm 118 to rotate relative to the support column 116 about a pivot axis defined by a pivot shaft 240. The pivot joint 236 includes a pivot sleeve 238 that is coupled to the proximal end of the proximal beam 206. In some embodiments, the pivot sleeve 238 is a short length of tubing that is releasably or permanently fastened to the proximal end of the proximal beam 206. The pivot shaft 240 extends upward through the pivot sleeve 238 and defines the pivot axis about which the arm 118 rotates. The pivot sleeve 238 and the pivot shaft 240 can be made of any suitable material. Preferably, the pivot sleeve 238 and/or pivot shaft 240 are made of a strong, wear-resistant material such as steel, stainless steel, or the like. In some embodiments, the pivot shaft 240 is a custom component machined from raw steel bar stock.

The pivot joint 236 also includes bushings 242 that fit inside the ends of the pivot sleeve 238. The bushings 242 have an inner diameter that is slightly larger than the diameter of the pivot shaft 240, allowing the pivot shaft 240 to rotate freely inside the bushings 242. The bushings 242 can be made of any suitable material that provides a low friction interface with the pivot shaft 240 such as brass, bronze, plastic, or the like. The pivot shaft 240 includes raised bearing surfaces 246 that are in rotational contact with the bushings 242.

The upper end of the pivot shaft 240 is coupled to the support column 116 with a pivot shaft adapter 244. The pivot shaft adapter 244 can be made of any suitable material such as metal or plastic. In some embodiments, the pivot shaft adapter 244 has a round lengthwise hole that is sized to receive the upper end of the pivot shaft 240. The pivot shaft adapter 244 also has a square exterior profile that fits snugly inside the square profile of the distal end of the distal extension 188 of the support column 116.

The pivot shaft 240 is inserted upward through the pivot sleeve 238 and into the pivot shaft adapter 244. The pivot shaft 240 and the pivot shaft adapter 244 are inserted into the distal end of the distal extension 188. The pivot shaft 240 and the pivot shaft adapter 244 have holes that align with holes in the distal extension 188. One or more fasteners are inserted through the aligned holes to couple the pivot shaft 240 to the support column 116 in a fixed manner. The fastener can be a bolt, pin, or the like.

### Rotation Restrictor Mechanism

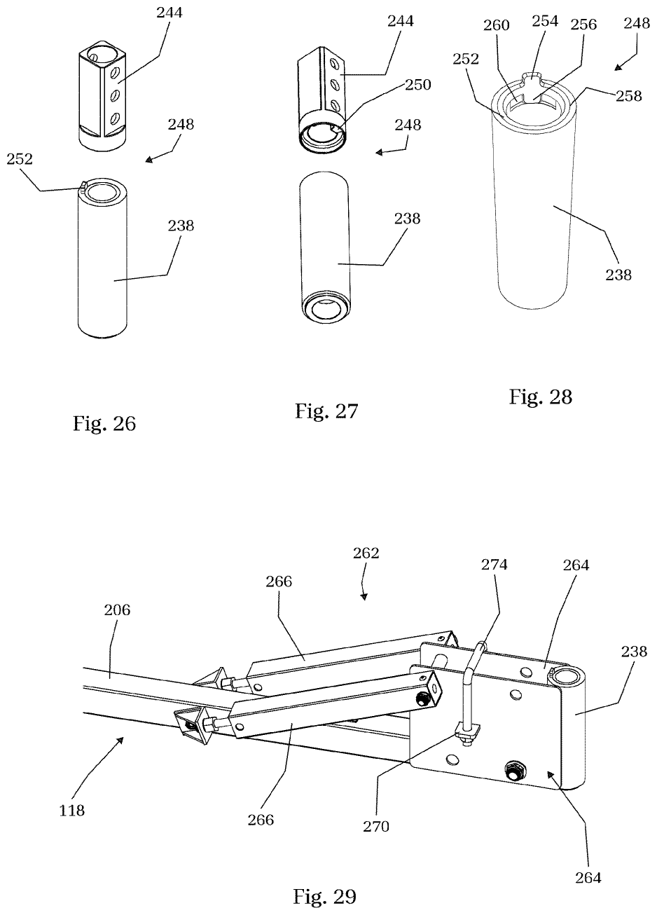

Referring to FIGS. 26-28, the cable management system 104 includes a rotation restrictor mechanism 248 that limits the rotation of the arm 118 relative to the support column 116. The rotation restrictor mechanism 248 prevents the arm 118 from rotating beyond a set amount to prevent damage to the charge cable 110, charging unit 106, and/or other components of the cable management system 104. For example, rotating the arm 118 in multiple circles could twist the charge cable 110 and damage it.

The rotation restrictor mechanism 248 includes a rotation stop 250 positioned in an annular recess of the pivot shaft adapter 244 and a rotation limiter 252 positioned at and extending upward from the upper end of the pivot sleeve 238. The rotation stop 250 and the rotation limiter 252 are structured to contact each other to limit rotation of the arm 118.

In one embodiment shown in FIGS. 26-27, the rotation limiter 252 is a protrusion or tab that extends upward from or is fixed to the top of the pivot sleeve 238. For example, the protrusion can be formed as an integral part of the pivot sleeve 238 by simply cutting away the top circumference of the pivot sleeve 238 except for the area that forms the protrusion. The rotation limiter 252 is positioned to contact the rotation stop 250 when the arm 118 is rotated to a predetermined position in either direction. Contact between the rotation limiter 252 and the rotation stop 250 prevents the arm 118 from rotating past the predetermined position.

This embodiment prevents the proximal beam 206 of the arm 118 from rotating in a full circle. In some embodiments, the rotation restrictor mechanism 248 having this configuration is structured to limit rotation of the arm 118 to a range of approximately 270-330 degrees.

In another embodiment shown in FIG. 28, the rotation limiter 252 is structured to rotate relative to the pivot sleeve 238 and thereby allow the arm 118 to rotate more than 360 degrees. For example, the rotation limiter 252 can be an annular metal ring with stops 254, 256 that protrude outward in opposite directions along the axis of the ring. The annular metal ring can be machined or otherwise formed specifically for this purpose.

The pivot sleeve 238 includes an annular recess 258 that is sized and shaped to rotatably receive the annular metal ring of the rotation limiter 252. The pivot sleeve 238 also includes a slot 260 that extends partway around the circumference of the annular recess 258. The stop 256 on the rotation limiter 252 is positioned in the slot 260. The stop 256 can rotate freely between the ends of the slot 260, allowing the rotation limiter 252 to rotate relative to the pivot sleeve 238.

The rotation restrictor mechanism 248 limits the rotation of the arm 118 in the following manner. As the arm 118 and the pivot sleeve 238 rotate, the stop 254 on the rotation limiter 252 rotates until it contacts the rotation stop 250 on the pivot shaft adapter 244. At this point, the rotation limiter 252 can no longer rotate relative to the pivot shaft adapter 244. However, the rotation limiter 252 can continue rotating relative to the pivot sleeve 238 until the stop 256 reaches one of the ends of the slot 260.

The ability of the rotation limiter 252 to rotate relative to both the pivot shaft adapter 244 and the pivot sleeve 238 makes it possible for the arm 118 to rotate more than 360 degrees. The additional rotation provided by the second embodiment of the rotation restrictor mechanism 248 allows the arm 118 to position the charge plug 112 anywhere within a full circle around the cable management system 104.

In this embodiment, the rotation restrictor mechanism 248 can be used to allow rotation of at least 360 degrees but not more than 540 degrees. For example, the rotation restrictor mechanism 248 can be used to allow rotation of 360-540 degrees. The length of the slot 260 determines the amount of rotation that is allowed.

In some embodiments, the rotation restrictor mechanism 248 is an internal mechanism that is covered by the pivot shaft adapter 244. As described above, the pivot shaft adapter 244 includes an annular recess where the rotation stop 250 is positioned. When the arm 118 is coupled to the support column 116, the outer diameter of the pivot shaft adapter 244 completely covers the rotation stop 250 and the rotation limiter 252, shielding them from view and from contact with other components.

Covering the rotation stop 250 and the rotation limiter 252 with the pivot shaft adapter 244 provides several benefits. First, it gives the pivot joint 236 a clean, finished appearance by concealing the functional components of the rotation restrictor mechanism 248. This improves the overall aesthetics of the cable management system 104. Second, covering the rotation stop 250 and the rotation limiter 252 eliminates pinch points that could damage the charge cable 110. If the rotation stop 250 and the rotation limiter 252 were left exposed, the charge cable 110 could become pinched between them when the arm 118 is rotated, potentially damaging the internal wires of the charge cable 110 and/or causing a dangerous condition. Third, in the embodiment where the arm 118 can rotate more than a full circle, covering the rotation stop 250 and the rotation limiter 252 retains the rotation limiter 252 in the annular recess 258 in the pivot sleeve 238.

### Overload Protection

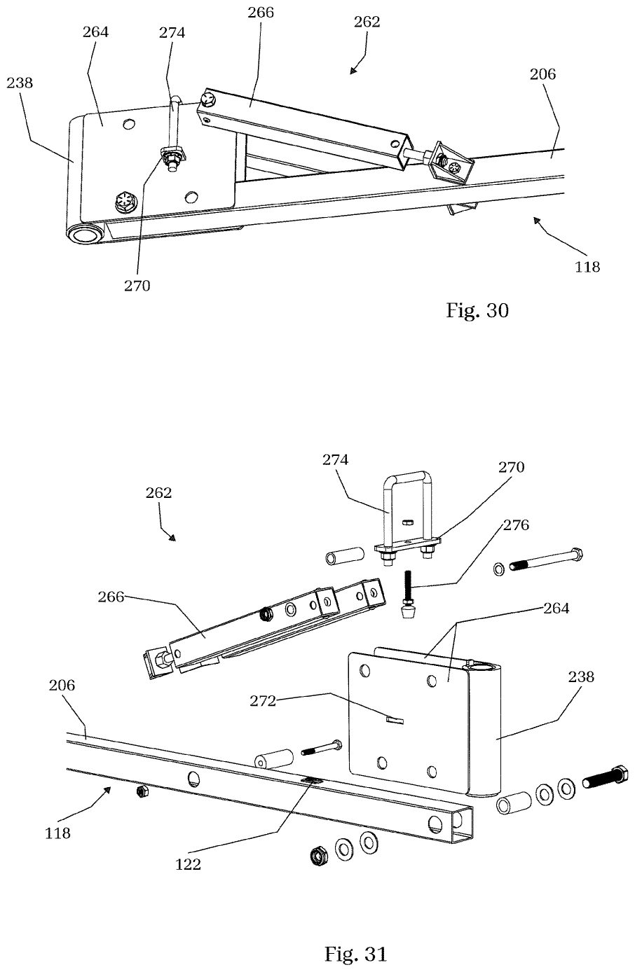

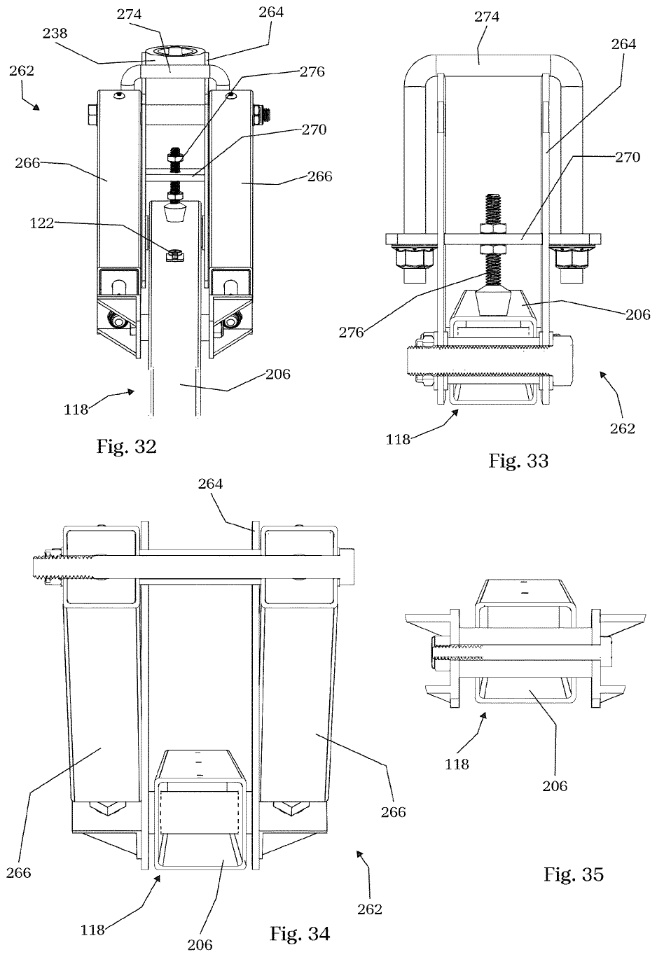

Referring to FIGS. 29-31, the cable management system 104 can include an overload mechanism 262 that protects the arm 118 and other components of the cable management system 104 from damage due to excessive loads. The overload mechanism 262 allows the arm 118 to rotate downward when subjected to an unusual or excessive force, preventing potential breakage or other damage.

The arm 118 includes support plates 264 that are welded to and extend outward from the pivot sleeve 238. The proximal end of the proximal beam 206 is coupled to the bottom of the support plates 264 in a manner that allows the arm 118 to rotate downward relative to the ceiling.

The overload mechanism 262 includes two spring mechanisms 266 that hold the arm 118 in a horizontal position under normal conditions. The force of gravity exerts a downward force on the arm 118, which in turn puts a tension force on the spring mechanisms 266. The spring mechanisms 266 are configured to provide sufficient upward force to counteract the gravitational force and maintain the arm 118 in a horizontal position during normal operation.

However, if an excessive load is placed on the arm 118, the downward force may exceed the upward force provided by the spring mechanisms 266. In this scenario, spring mechanisms 266 allow the arm 118 to rotate downward, preventing potential damage to the arm 118 or other components of the cable management system 104. This downward rotation acts as a safety mechanism, allowing the arm 118 to yield to the excessive force instead of breaking or causing other damage.

The overload mechanism 262 also includes a stop mechanism 268 that prevents the spring mechanisms 266 from rotating the arm 118 upward past the horizontal position. The stop mechanism 268 comprises a plate 270 that extends horizontally through slots 272 in the support plates 264. A U-bolt 274 fits over the top of the support plates 264, with its threaded ends extending through holes in each end of the plate 270.

A stop device 276 is positioned in the middle of the plate 270. The stop device 276 includes a threaded shaft that passes through a hole in the middle of the plate 270. The position of the stop device 276 can be adjusted using nuts positioned on the threaded shaft. The stop device 276 can be adjusted to contact the top of the proximal beam 206 and thereby limit its upward rotation. This can help prevent the arm 118 from rotating too high and interfering with the opening/closing of a garage door.

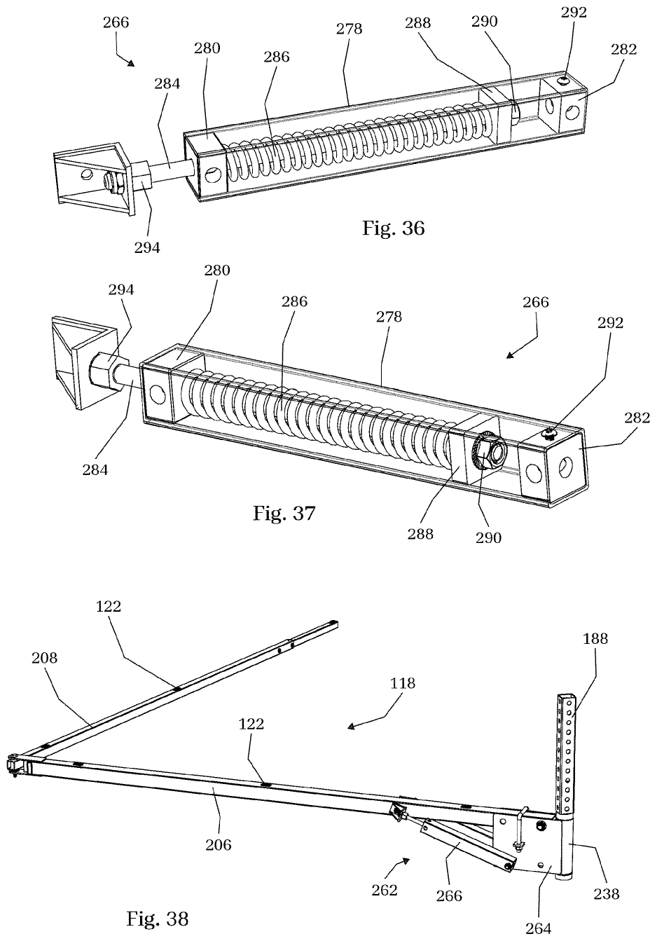

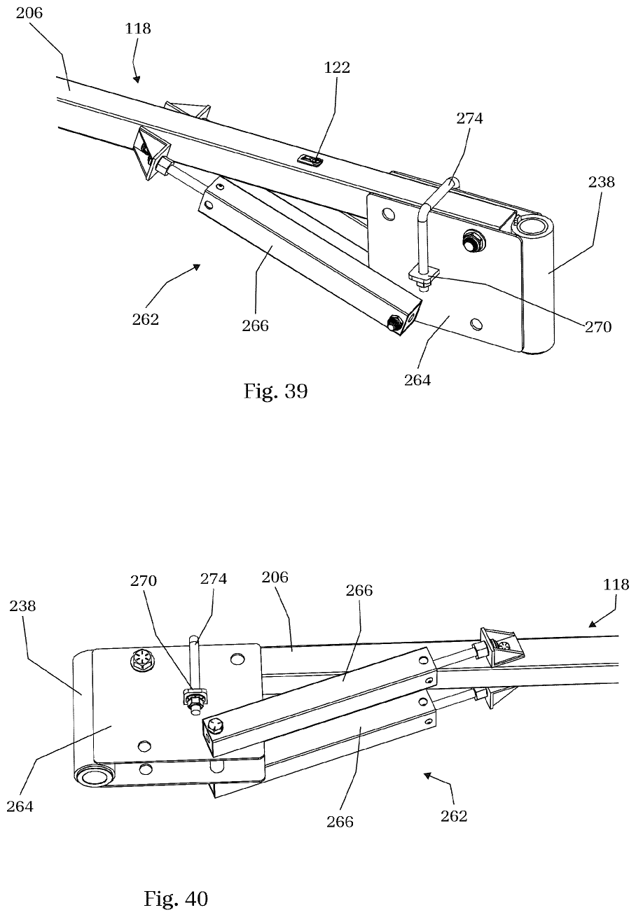

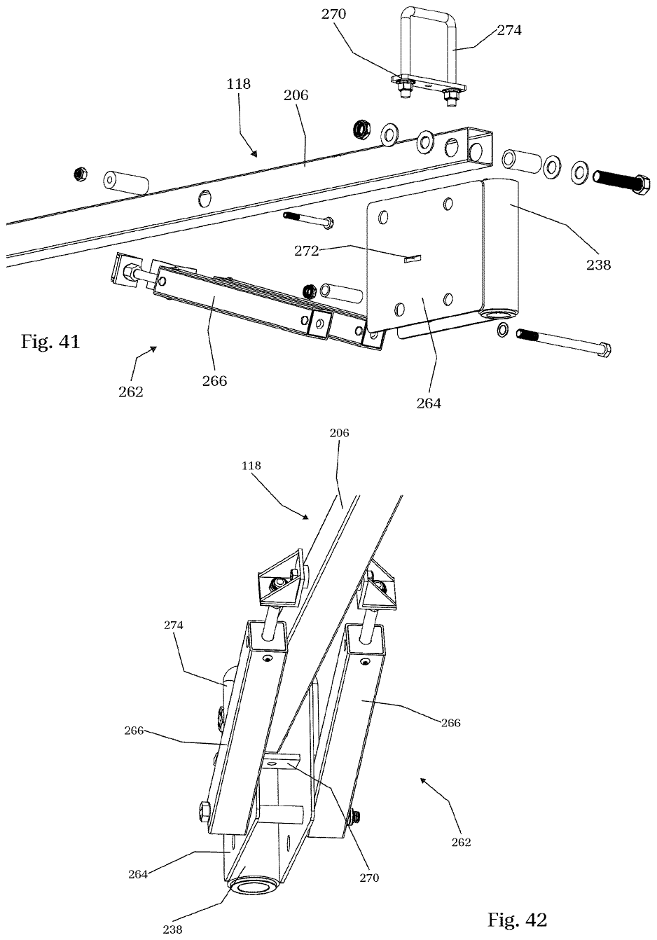

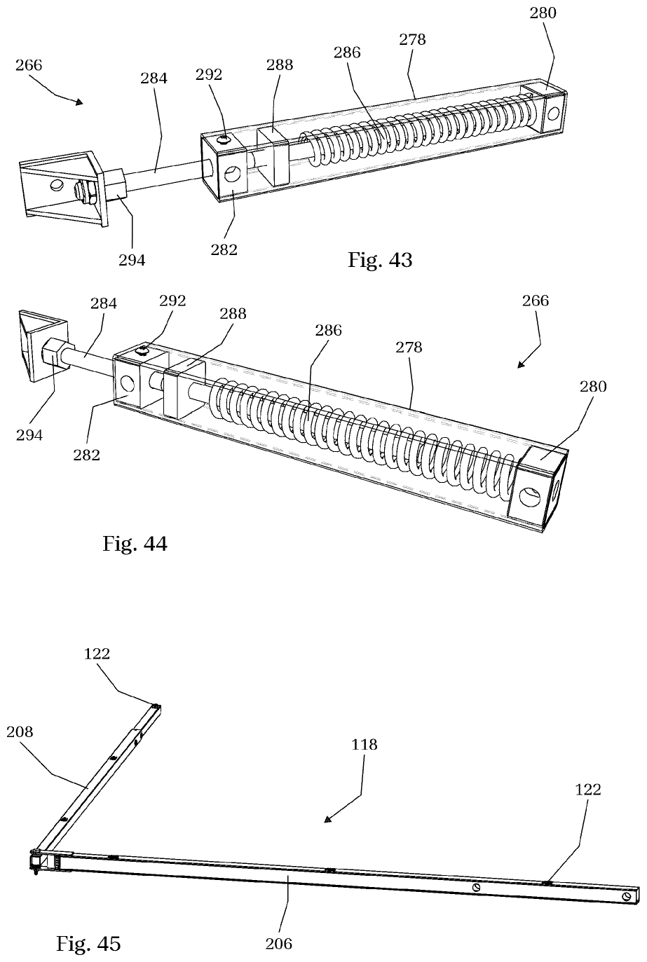

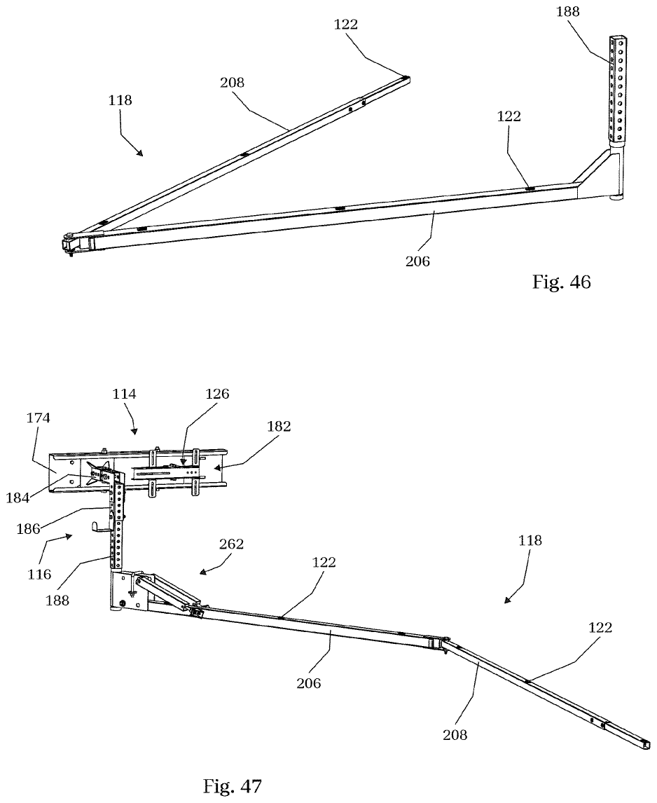

Referring to FIGS. 36-37, the spring mechanisms 266 of the overload mechanism 262 are shown in a tension configuration in the sense that the arm 118 applies a tension load to the spring mechanism 266. Each spring mechanism 266 comprises a square tubular housing 278 with a fixed plug 280 at one end and a removable plug 282 at the other end.

The fixed plug 280 is permanently attached to one end of the square tubular housing 278, such as by welding, press-fitting, or adhesive bonding. The fixed plug 280 includes a hole through which a shaft 284 extends into the interior of the square tubular housing 278. The hole in the fixed plug 280 is sized to allow the shaft 284 to rotate freely while preventing significant lateral movement.

The removable plug 282 is located at the opposite end of the square tubular housing 278 from the fixed plug 280. The removable plug 282 can be secured to the square tubular housing 278 using various methods, such as with fasteners 292. The removable plug 282 allows access to the interior of the square tubular housing 278 so the spring mechanisms 266 can be changed from the tension configuration to a compression configuration when the arm 118 applies a compression load on the spring mechanisms 266.

Inside the square tubular housing 278, the shaft 284 passes through a spring 286. The spring 286 is a compression spring that provides the force necessary to hold the arm 118 in a horizontal position. The spring 286 is positioned between the fixed plug 280 and a square nut 288 that is threaded onto the shaft 284.

The portion of the shaft 284 that extends inside the square tubular housing 278 is at least partially threaded. In some embodiments, at least half of the shaft 284 inside the square tubular housing 278 is threaded. The square nut 288 is threaded onto the shaft 284 and is sized to fit snugly within the square tubular housing 278. The square shape of the nut 288 and the corresponding square interior of the tubular housing 278 prevent the square nut 288 from rotating when the shaft 284 is turned. This allows the square nut 288 to translate linearly along the shaft 284 when the shaft 284 is rotated, thereby compressing or decompressing the spring 286.

A lock nut 290 is positioned at the end of the shaft 284. The lock nut 290 is configured to rotate with the shaft 284 and acts as a safety mechanism to prevent the inadvertent complete removal of the shaft 284 from the square nut 288. If the shaft 284 is rotated to the point where the square nut 288 reaches the end of the threaded portion of the shaft 284, the lock nut 290 will contact the square nut 288 and prevent further rotation, thereby ensuring that the spring mechanism 266 does not come apart unexpectedly.

The tension in the spring 286 can be adjusted by rotating the shaft 284 using, for example, a nut 294 permanently fixed to the shaft 284 outside the tubular housing 278. For example, the nut 294 can be tack welded to the shaft 284. Rotating the shaft 284 in one direction (e.g., clockwise) causes the square nut 288 to move linearly along the shaft 284 towards the fixed plug 280, thereby compressing the spring 286 and increasing the force it provides to hold the arm 118 in a horizontal position. Conversely, rotating the shaft 284 in the opposite direction (e.g., counterclockwise) moves the square nut 288 away from the fixed plug 280, decompressing the spring 286 and decreasing the force it applies to the arm 118.

This allows the user to fine-tune the amount of force the spring mechanisms 266 apply to the arm 118, so that the arm 118 remains horizontal under normal conditions while still allowing it to rotate downward when subjected to excessive loads. It is especially useful to account for varying amount of weight exerted on the arm 118 when the length, gauge, and weight of the charge cable 110 varies. The lock nut 290 serves to prevent the accidental disassembly of the spring mechanism 266 during adjustment or operation.

In some embodiments, the cable management system 104 can be reconfigured to extend the arm 118 outward from the top of the support plates 264 instead of the bottom. This configuration may be advantageous in situations where there are obstacles on the ceiling or the user prefers having the arm 118 positioned higher relative to the support column 116. The support plates 264 include holes that make it a simple matter to couple the arm 118 at either the top or the bottom. Moving the arm 118 to the top is simply a matter of bolting the proximal beam 206 to the holes at the top of the support plates 264.

With the proximal beam 206 coupled to the top of the support plates 264, the spring mechanisms 266 need to be repositioned to apply the necessary force to hold the arm 118 horizontal. In this configuration, the spring mechanisms 266 are coupled to the bottom of the support plates 264 and extend upward to connect to the proximal beam 206. This arrangement results in the arm 118 applying a compression force on the spring mechanisms 266, as opposed to the tension force applied in the previous configuration.

To reconfigure the spring mechanisms 266 for this new arrangement, the first step is to remove the removable plug 282 from the end of the square tubular housing 278. With the removable plug 282 removed, the lock nut 290 is removed from the shaft 284. The shaft 284 is then unscrewed from the square nut 288, which allows the shaft 284 to be completely removed from the spring mechanism 266 by pulling it through the hole in the fixed plug 280.

With the shaft 284 removed, the spring 286 and square nut 288 can be taken out of the square tubular housing 278. At this point, the spring mechanism 266 is ready to be reassembled in the new configuration.

To reassemble the spring mechanism 266, the shaft 284 is first inserted through a hole in the removable plug 282. The shaft 284 is then screwed into the square nut 288. It is important to note that the shaft 284 should be screwed a significant distance into the square nut 288 before proceeding to the next step. This ensures that there will be sufficient room for the spring 286 to be compressed when the spring mechanism 266 is fully assembled.

With the shaft 284 attached to the square nut 288, the spring 286 is placed over the shaft 284. The entire assembly, which includes the shaft 284, square nut 288, and spring 286, is then inserted into the open end of the square tubular housing 278. The removable plug 282 is then fastened securely to the tubular housing 278 with the fasteners 292.

In this new configuration, the spring 286 is positioned between the square nut 288 and the fixed plug 280. When the spring mechanism 266 is fully assembled and installed, the spring 286 will be compressed between these two components, providing the necessary force to hold the arm 118 in a horizontal position.

Just as in the previous configuration, the force applied by the spring 286 can be adjusted by rotating the shaft 284. This is done using the fixed nut 294 that is permanently attached to the shaft 284 outside the tubular housing 278 to rotate the shaft 284. Rotating the shaft 284 in one direction (e.g., counterclockwise) will cause the square nut 288 to move linearly along the shaft 284 towards the removable plug 282, compressing the spring 286 and increasing the force it applies to the arm 118. Rotating the shaft 284 in the opposite direction (e.g., clockwise) will move the square nut 288 away from the removable plug 282, decompressing the spring 286 and decreasing the force it applies.

In this configuration, the lock nut 290 is not used. This is because rotating the shaft 284 in the direction that decreases the force applied by the spring 286 will eventually cause the square nut 288 to contact the removable plug 282. This contact will prevent further rotation of the shaft 284, thereby preventing the accidental disassembly of the spring mechanism 266.

By allowing the arm 118 to be positioned above the support plates 264 and the spring mechanisms 266 to be reconfigured to apply a compression force, the cable management system 104 offers increased flexibility in installation and configuration. This adaptability allows the system to be optimized for a wider variety of garage layouts and user preferences.

When the cable management system 104 is reconfigured so that the arm 118 extends outward from the top of the support plates 264, the stop mechanism 268 used in the previous configuration is not used.

In the tension configuration, the stop mechanism 268 was used to prevent the arm 118 from rotating upward past the horizontal position. This was accomplished by adjusting the stop device 276 to contact the top of the proximal beam 206, thereby limiting its upward rotation.

However, in the compression configuration, the U-bolt 274 of the stop mechanism 268 prevents the upward rotation of the arm 118 past the horizontal position. The U-bolt 274 is positioned across the top of the support plates 264, with its threaded ends extending through the holes in the plate 270. When the nuts are tightened on the threaded ends of the U-bolt 274, it securely clamps the plate 270 to the top of the support plates 264.

In this position, the U-bolt 274 acts as a physical barrier that prevents the arm 118 from rotating upward past the horizontal position. If the arm 118 were to start rotating upward, the top of the proximal beam 206 would come into contact with the underside of the U-bolt 274. This contact would stop any further upward rotation, thereby keeping the arm 118 at or below the horizontal position.

### Cable Management System-Wall Mount

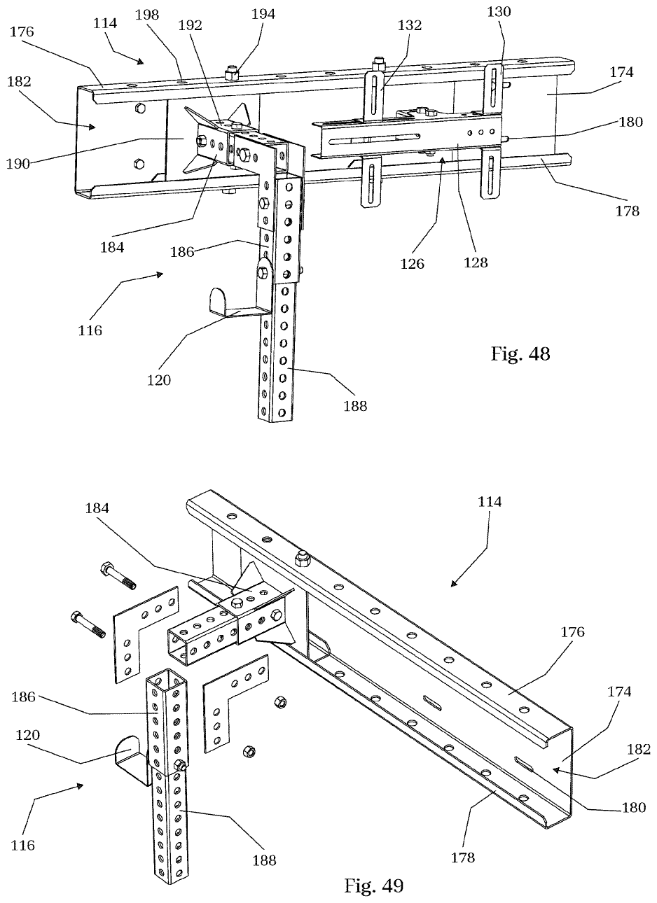

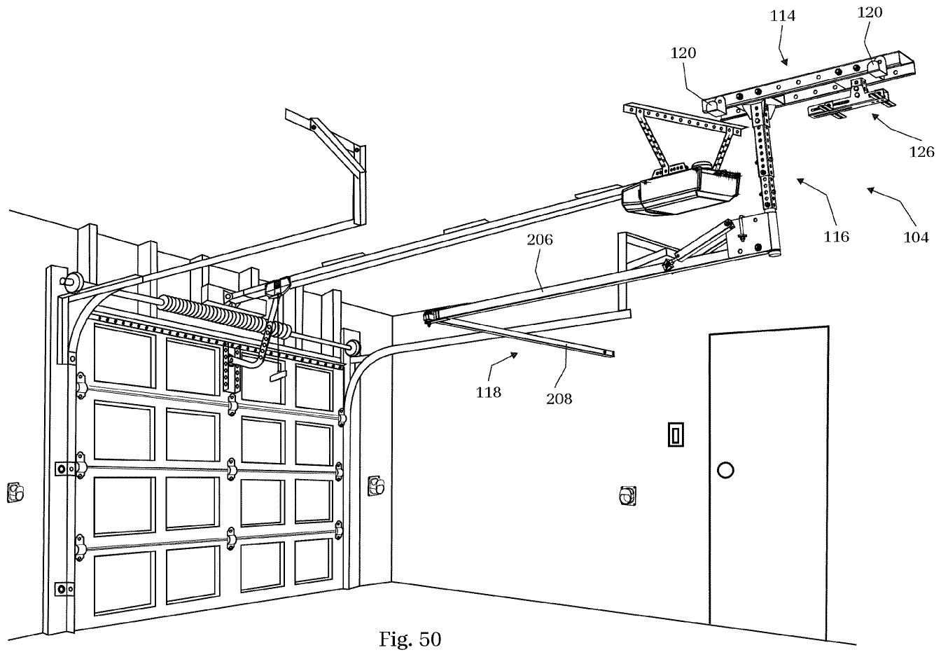

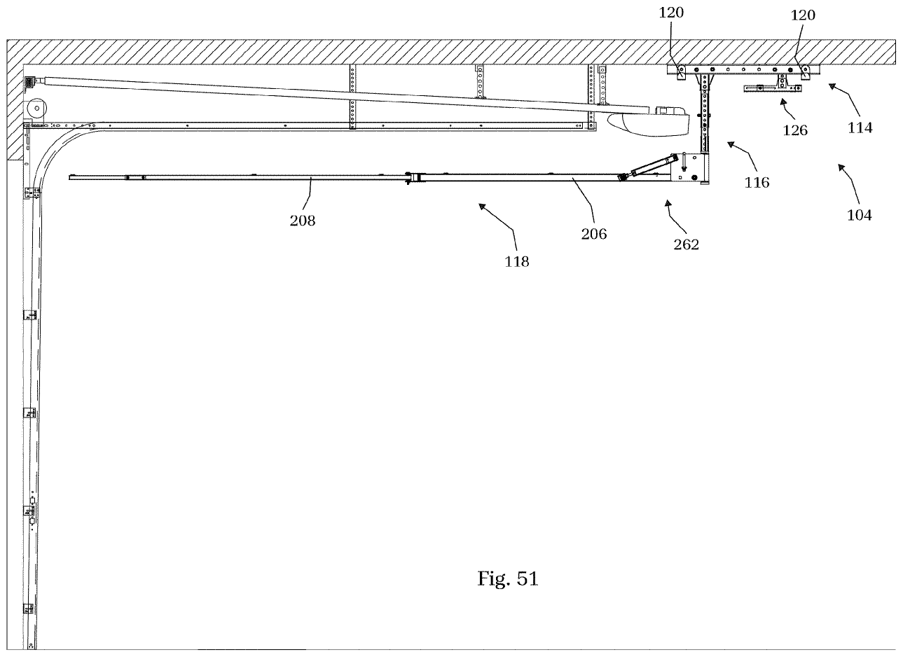

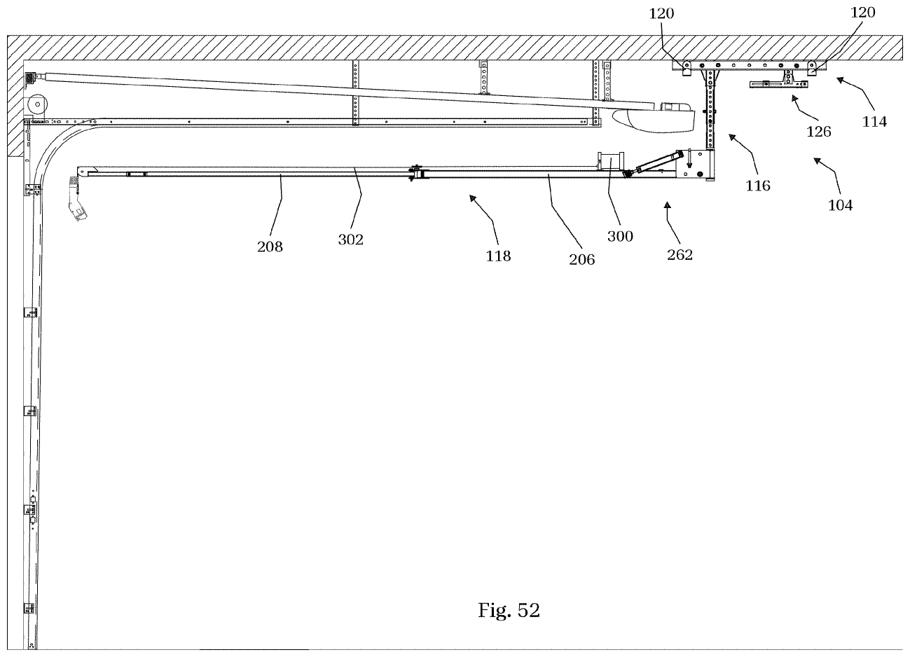

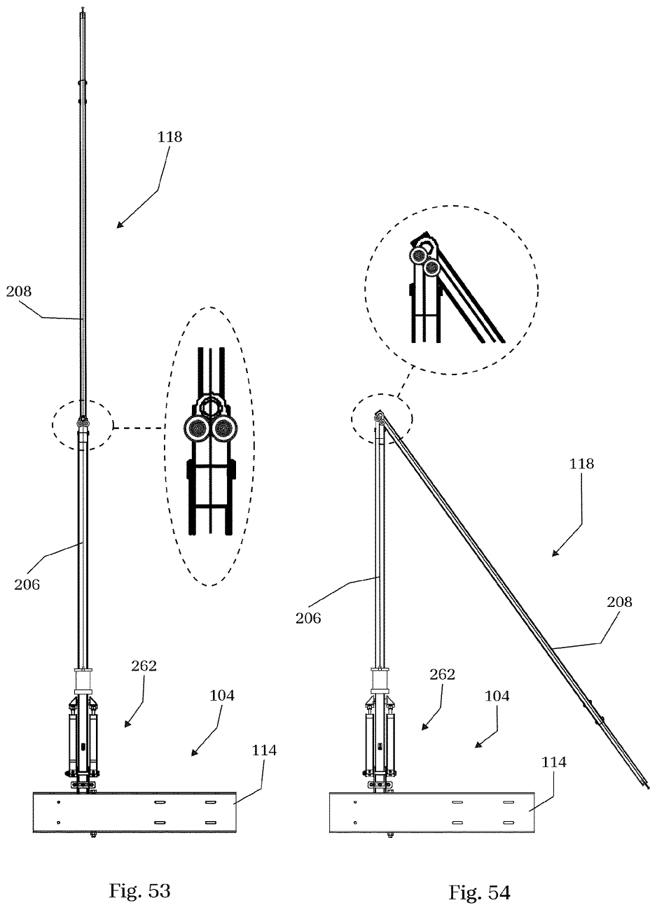

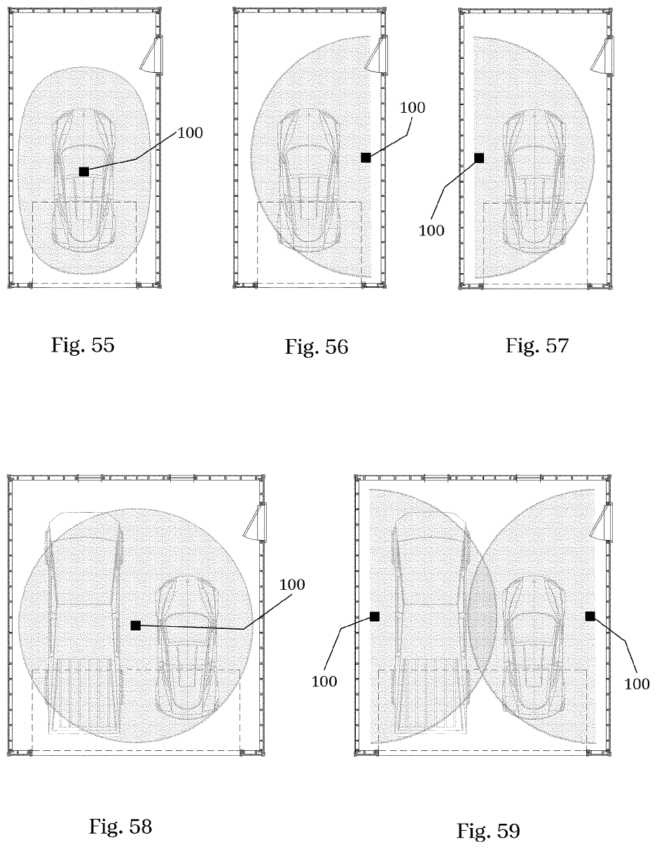

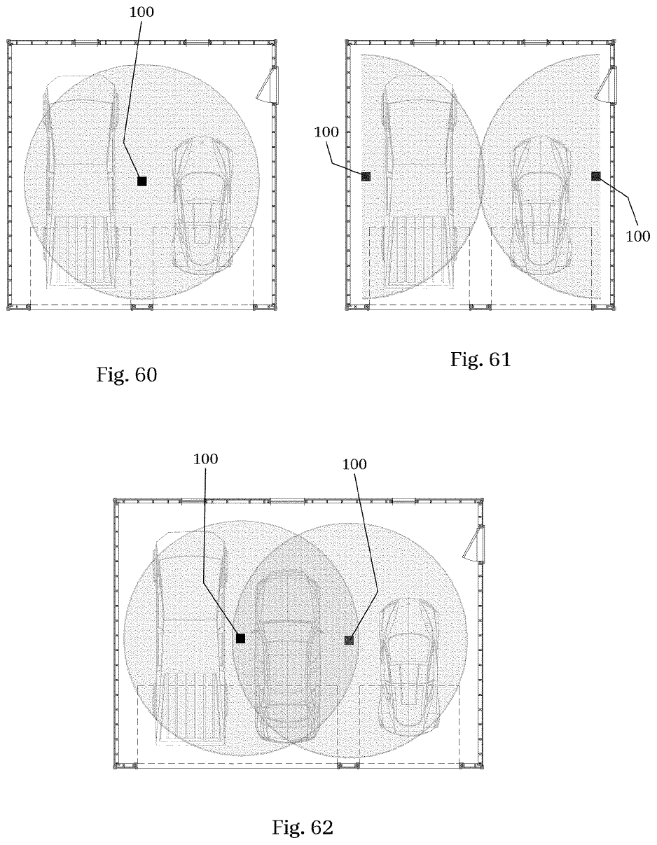

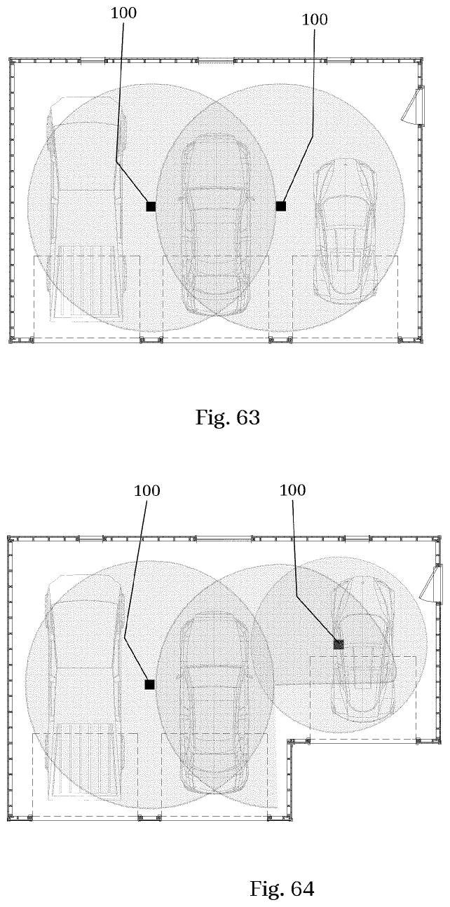

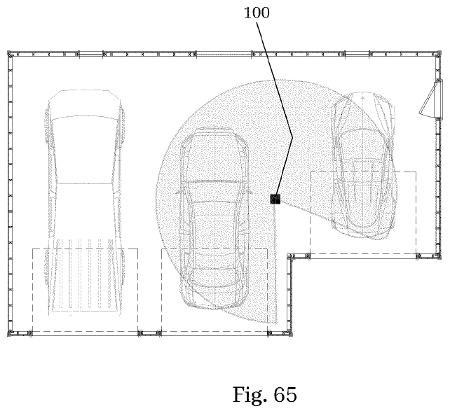

In addition to the ceiling mount configuration, the cable management system 104 can also be designed for wall mounting as shown in FIGS. 47-49. The wall mount version shares many similarities with the ceiling mount version, with a few key differences to accommodate the requirements of wall installation.

In the wall mount version, the base 114 is mounted to the wall of the structure instead of the ceiling. This allows the cable management system 104 to be installed in situations where ceiling mounting is not desirable, such as in garages with limited overhead space or where ceiling is not suitable for mounting the system.

The base 114 used in the wall mount version can be similar in design to the one used in the ceiling mount version. It can include features such as mounting holes, a channel for sliding the support column 116, and provisions for attaching accessories like the charger mount 126.

One difference between the wall mount and ceiling mount versions is the shape of the support column 116. In the wall mount version, the support column 116 has an L-shape to allow the arm 118 to extend outward horizontally from the wall at the appropriate height and orientation.

The L-shape of the support column 116 can be achieved by modifying the design of the proximal extension 186. Instead of a single straight piece, the proximal extension 186 in the wall mount version can be provided as two pieces that are fastened together at a 90-degree angle.

The two pieces of the proximal extension 186 can be joined using one or more 90-degree elbows or brackets. The elbows or brackets can be a separate component that is designed to securely connect the two pieces of the proximal extension 186, creating a rigid L-shape. Alternatively, the two pieces of the proximal extension 186 can be fabricated with a 90-degree bend, eliminating the need for a separate elbow or bracket.

The distal extension 188 of the support column 116 remains vertical in the wall mount version, just like in the ceiling mount version. This makes it so the arm 118 extends outward from the wall at the appropriate height and orientation for convenient access to the charge cable 110 and charger plug 112.

The vertical orientation of the distal extension 188 also allows the use of the same pivot joint 236 and other components as in the ceiling mount version. Of course, the wall mount version does not need the rotation restrictor mechanism. Other components of the cable management system 104, such as the arm 118, spring mechanisms 266, stop mechanism 268, and charger mount 126, can be used in the wall mount version without significant modifications. The modular design of these components allows them to be easily integrated into both the ceiling mount and wall mount configurations.

It should be appreciated that both the wall mount and ceiling versions can be installed indoors or outdoors.

### Motorized Charge Plug Lift

The cable management system 104 can be equipped with a motorized charge plug lift to provide an automated means of raising and lowering the charge plug 112. This feature enhances the convenience and accessibility of the system, making it easier for users to handle the charge plug 112 when connecting or disconnecting their electric vehicle.

The motorized charge plug lift comprises a motor 300 coupled to the arm 118, typically at the proximal end of the proximal beam 206. The motor 300 can be an electric motor, such as a DC gear motor, that is powered by the electrical system of the structure or by a separate power source, such as a battery.

The motor 300 is configured to wind and unwind a cable 302 that extends outward along the top of the arm 118. The cable 302 runs from the motor 300, across the top of the proximal beam 206, and continues along the top of the distal beam 208. The cable 302 can be guided along the arm 118 by a series of pulleys or guides to ensure smooth and controlled movement.

The distal end of the cable 302 is attached to the charge plug 112. This attachment can be made using a variety of methods, such as a hook, a clip, or a specialized connector designed to securely hold the charge plug 112 without damaging it.

When the motor 300 is activated to wind the cable 302, it retracts the cable 302 and lifts the charge plug 112 upward toward the arm 118. This allows the charge plug 112 to be easily stored and kept out of the way when not in use. The motor 300 can be controlled to stop winding the cable 302 when the charge plug 112 reaches a predetermined height or when it comes into contact with a limit switch positioned on the arm 118.

Conversely, when the motor 300 is activated to unwind the cable 302, it extends the cable 302 and the charge plug 112 lowers toward the ground. This allows the user to easily access the charge plug 112 when they need to connect their electric vehicle for charging. The motor 300 can be controlled to stop unwinding the cable 302 when the charge plug 112 reaches a predetermined height or when the user manually stops the motor 300.

The motor 300 can be controlled using a variety of methods, such as a switch or button located on the arm 118, a remote control, or a smartphone app. The control system can include safely features, such as an automatic stop function that prevents the motor 300 from overwinding or overwinding the cable 302, which could cause damage to the system or the charge plug 112.

To ensure smooth and reliable operation of the motorized charge plug lift, the cable 302 can be made from a durable and flexible material, such as braided steel or high-strength synthetic fibers. The cable 302 should be strong enough to support the weight of the charge plug 112 and withstand the repeated winding and unwinding cycles without stretching or breaking.

The pulleys or guides used to direct the cable 302 along the arm 118 can be designed to minimize friction and wear on the cable 302. They can be made from materials such as plastic or metal with smooth surfaces to reduce abrasion and ensure the cable 302 slides easily.

The motorized charge plug lift can be seamlessly integrated into the overall design of the cable management system 104. The motor 300 can be mounted on the arm 118 in a way that minimizes its visual impact and protects it from damage. The cable 302 can be routed along the arm 118 in a manner that is both functional and aesthetically pleasing.

The charger cable can be coupled to a sliding mechanism at a location proximal of the guide pulleys. For example, the proximal or distal section of the arm can include a slotted track (e.g., can be made of slotted aluminum) the charge cable can be fastened to a sliding insert that moves along the slotted aluminum. Examples of suitable slotted aluminum and sliding inserts can be found in the incorporated documents.

### Additional Features

Lifting mechanism can be a Bal-Trol mini PV03/4-5-N (pneumatic). However, an electric lift mechanism can be used as well. For example, lifting mechanism can be similar to an electric winch.

Lifting mechanism can be configured to only lift when the cap is placed on the charger plug. This ensures that lifting mechanism will not raise charger plug when it is plugged into the vehicle. The cap can be configured to communicate with the lifting mechanism in a variety of ways such as with a wire or wirelessly. Can include a cord attached to the charger plug that allows it to be pulled down. For the retractable version, the CMS does not have access to the EV charger system to know when it is unplugged. This is why the cap is so useful.

### Materials

The various components (structural components, fasteners, and the like) of the cable management system 104 can be made of any suitable material or combination of materials that provide the desired strength, durability, corrosion resistance, and aesthetic properties.

For indoor applications, such as in a residential or commercial garage, the components of the cable management system 104 can be made of cost-effective and durable materials such as galvanized steel or painted steel. Galvanized steel is advantageous because it is resistant to corrosion and requires minimal maintenance. It also matches the look of most garage door hardware. The steel can be galvanized using various methods, such as hot-dip galvanizing, electroplating, thermal spraying, or the like, depending on the desired thickness and uniformity of the protective zinc coating.

Painted steel is another suitable option for indoor applications. The steel components can be coated with a durable, protective paint, such as a powder coat or epoxy paint, to enhance their appearance and resistance to wear and corrosion. The paint color can be selected to match or complement the décor of the garage or other indoor space.

For outdoor applications or environments with high humidity or exposure to corrosive elements, the components of the cable management system 104 can be made of materials with enhanced corrosion resistance. For example, in some embodiments, the components can be made of stainless steel, which contains chromium and other alloying elements that form a protective oxide layer on the surface, making it highly resistant to rust and corrosion. Various grades of stainless steel, such as 304 or 316, can be used depending on the desired level of corrosion resistance.

In other embodiments, the components of the cable management system 104 can be made of aluminum. It is lightweight, strong, and naturally resistant to corrosion due to the formation of a protective oxide layer on its surface. Aluminum can be further protected by applying a durable, weather-resistant coating, such as a powder coat or anodized finish.

In some cases, the components of the cable management system 104 can be made of titanium or other specialty alloys. Titanium has an exceptional strength-to-weight ratio and excellent corrosion resistance, making it suitable for the most demanding applications. In addition to metals, the components of the cable management system 104 can also be made of high-strength, corrosion-resistant polymers or composite materials. These materials can be particularly useful for applications where electrical insulation, lightweight, or specific aesthetic properties are desired.

### ILLUSTRATIVE EMBODIMENTS

The following is a description of various embodiments of the disclosed subject matter. Each embodiment may include one or more of the various features, characteristics, or advantages of the disclosed subject matter. The embodiments are intended to illustrate a few aspects of the disclosed subject matter and should not be considered a comprehensive or exhaustive description of all possible embodiments.

Paragraph 1. Any novel combination of subject matter described in this document including processes, methods, machines, manufactures, apparatuses, and the like.

Paragraph 2. The subject matter described in Paragraph 1 wherein the subject matter includes any combination of any two or more aspects that are possibly conceivable in view of the description.

Paragraph 3. A cable management system for an electric vehicle charger, the cable management system comprising: a base structured to be coupled to a ceiling of a structure; a support column slidingly coupled to and extending downward from the base; and an arm rotatably coupled to the support column and extending horizontally or approximately horizontally outward from the support column.

Paragraph 4. The cable management system of Paragraph 3 wherein the support column is structured to be fixed to the base at multiple locations along the length of the base.

Paragraph 5. The cable management system of Paragraph 3 wherein the support column slides along the length of the base.

Paragraph 6. The cable management system of Paragraph 5 wherein the support column includes a mount that slides along the length of the base.

Paragraph 7. The cable management system of Paragraph 3 wherein the base includes a channel and the support column slides along the channel.

Paragraph 8. The cable management system of Paragraph 3 wherein the base includes a C-shaped channel and the support column slides along the C-shaped channel.

Paragraph 9. The cable management system of Paragraph 3 wherein the arm comprises a proximal beam rotatably coupled to the support column and a distal beam rotatably coupled to the proximal beam.

Paragraph 10. An electric vehicle charging system comprising: a cable management system comprising: a base coupled to a ceiling of a structure; a support column slidingly coupled to and extending downward from the base; and an arm rotatably coupled to the support column and extending horizontally or approximately horizontally outward from the support column; and an electric vehicle charger comprising: a charge cable coupled to and routed along the support column and the arm; and a charger plug hanging from a distal end of the arm.

Paragraph 11. The electric vehicle charging system of Paragraph 10 wherein the support column is structured to be fixed to the base at multiple locations along the length of the base.

Paragraph 12. The electric vehicle charging system of Paragraph 10 wherein the support column slides along the length of the base.

Paragraph 13. The electric vehicle charging system of Paragraph 12 wherein the support column includes a mount that slides along the length of the base.

Paragraph 14. The electric vehicle charging system of Paragraph 10 wherein the base includes a channel and the support column slides along the channel.

Paragraph 15. The electric vehicle charging system of Paragraph 10 wherein the base includes a C-shaped channel and the support column slides along the C-shaped channel.

Paragraph 16. The electric vehicle charging system of Paragraph 10 wherein the arm comprises a proximal beam rotatably coupled to the support column and a distal beam rotatably coupled to the proximal beam.

Paragraph 17. A cable management system for an electric vehicle charger, the cable management system comprising: a base structured to be coupled to a ceiling of a structure; a support column coupled to and extending downward from the base; and an arm rotatably coupled to the support column and extending horizontally or approximately horizontally outward from the support column, wherein the cable management system is structured to allow a charge cable to be coupled to and routed along the support column and the arm without disconnecting the charge cable from the electric vehicle charger or a charger plug.

Paragraph 18. The cable management system of Paragraph 17 wherein the support column comprises a rotation stop; and the arm comprises a rotation limiter; wherein the rotation limiter contacts the rotation stop to limit rotation of the arm.

Paragraph 19. The cable management system of Paragraph 17 wherein the arm comprises a proximal beam rotatably coupled to the support column and a distal beam rotatably coupled to the proximal beam.

Paragraph 20. An electric vehicle charging system comprising: a cable management system comprising: a base coupled to a ceiling of a structure; a support column coupled to and extending downward from the base; and an arm rotatably coupled to the support column and extending horizontally or approximately horizontally outward from the support column; and an electric vehicle charger comprising: a charge cable coupled to and routed along the support column and the arm; and a charger plug; wherein the cable management system is structured to allow the charge cable to be coupled to and routed along the support column and the arm without disconnecting the charge cable from the electric vehicle charger or the charger plug.

Paragraph 21. The electric vehicle charging system of Paragraph 20 wherein the support column comprises a rotation stop; and the arm comprises a rotation limiter; wherein the rotation limiter contacts the rotation stop to limit rotation of the arm.

Paragraph 22. The electric vehicle charging system of Paragraph 20 wherein the arm comprises a proximal beam rotatably coupled to the support column and a distal beam rotatably coupled to the proximal beam.

Paragraph 23. A cable management system for an electric vehicle charger, the cable management system comprising: a base structured to be coupled to a ceiling of a structure; a support column coupled to and extending downward from the base; and an arm rotatably coupled to the support column and extending horizontally or approximately horizontally outward from the support column, the arm comprising: a proximal beam rotatably coupled to the support column; and a distal beam rotatably coupled to the proximal beam.

Paragraph 24. The cable management system of Paragraph 19 wherein the distal beam is capable of pivoting to either side of a lengthwise axis defined by the proximal beam.

Paragraph 25. An electric vehicle charging system comprising: a cable management system comprising: a base coupled to a ceiling of a structure; a support column coupled to and extending downward from the base; and an arm rotatably coupled to the support column and extending horizontally or approximately horizontally outward from the support column, the arm comprising: a proximal beam rotatably coupled to the support column; and a distal beam rotatably coupled to the proximal beam; and an electric vehicle charger comprising: a charge cable coupled to and routed along the support column and the arm; and a charger plug hanging from a distal end of the arm.

Paragraph 26. The electric vehicle charging system of Paragraph 21 wherein the distal beam is capable of pivoting to either side of a lengthwise axis defined by the proximal beam.

Paragraph 27. A cable management system for an electric vehicle charger, the cable management system comprising: a base structured to be coupled to a ceiling of a structure; a support column coupled to and extending downward from the base; and an arm rotatably coupled to the support column, the arm comprising: a beam extending horizontally or approximately horizontally outward from the support column, the beam being structured to rotate downward relative to the support column; and a spring coupled to the beam, the spring being structured to hold the beam horizontally or approximately horizontally.

Paragraph 28. The cable management system of Paragraph 23 wherein the arm includes at least two springs coupled to the beam and structured to hold the beam horizontally or approximately horizontally.

Paragraph 29. The cable management system of Paragraph 23 wherein the spring is a mechanical spring.

Paragraph 30. The cable management system of Paragraph 23 wherein the spring is a gas spring.

Paragraph 31. The cable management system of Paragraph 23 wherein the beam applies a tension force to the spring.

Paragraph 32. The cable management system of Paragraph 23 wherein the beam applies a compression force to the spring.

Paragraph 33. The cable management system of Paragraph 23 wherein the arm comprises an overload mechanism that includes the spring, and wherein the overload mechanism is capable of being selectively configured between a first configuration where the beam applies a tension force to the spring and a second configuration where the beam applies a compression force to the spring.

Paragraph 34. The cable management system of Paragraph 23 wherein the arm includes a pivot sleeve rotatably coupled to the support column, wherein the beam is rotatably coupled to the pivot sleeve in a manner that allows the beam to rotate downward relative to the support column, and wherein the spring is coupled to the pivot sleeve and extends upward or downward at an angle relative to the beam.

Paragraph 35. The cable management system of Paragraph 23 wherein the arm is structured to rotate downward at least five degrees relative to the support column.

Paragraph 36. The cable management system of Paragraph 23 wherein the arm includes a pivot sleeve, and wherein the arm is structured to allow the beam to be coupled to the top of the pivot sleeve or the bottom of the pivot sleeve.

Paragraph 37. An electric vehicle charging system comprising: a cable management system comprising: a base coupled to a ceiling of a structure; a support column coupled to and extending downward from the base; and an arm rotatably coupled to the support column, the arm comprising: a beam extending horizontally or approximately horizontally outward from the support column, the beam being structured to rotate downward relative to the support column; and a spring coupled to the beam, the spring being structured to hold the beam horizontally or approximately horizontally; and an electric vehicle charger comprising: a charge cable coupled to and routed along the support column and the arm; and a charger plug hanging from a distal end of the arm.

Paragraph 38. The electric vehicle charging system of Paragraph 33 wherein the arm includes at least two springs coupled to the beam and structured to hold the beam horizontally or approximately horizontally.

Paragraph 39. The electric vehicle charging system of Paragraph 33 wherein the spring is a mechanical spring.

Paragraph 40. The electric vehicle charging system of Paragraph 33 wherein the spring is a gas spring.

Paragraph 41. The electric vehicle charging system of Paragraph 33 wherein the beam applies a tension force to the spring.

Paragraph 42. The electric vehicle charging system of Paragraph 33 wherein the beam applies a compression force to the spring.

Paragraph 43. The electric vehicle charging system of Paragraph 33 wherein the arm comprises an overload mechanism that includes the spring, and wherein the overload mechanism is capable of being selectively configured between a first configuration where the beam applies a tension force to the spring and a second configuration where the beam applies a compression force to the spring.

Paragraph 44. The electric vehicle charging system of Paragraph 33 wherein the arm includes a pivot sleeve rotatably coupled to the support column, wherein the beam is rotatably coupled to the pivot sleeve in a manner that allows the beam to rotate downward relative to the support column, and wherein the spring is coupled to the pivot sleeve and extends upward or downward at an angle relative to the beam.

Paragraph 45. The electric vehicle charging system of Paragraph 33 wherein the arm is structured to rotate downward at least five degrees relative to the support column.

Paragraph 46. The electric vehicle charging system of Paragraph 33 wherein the arm includes a pivot sleeve, and wherein the arm is structured to allow the beam to be coupled to the top of the pivot sleeve or the bottom of the pivot sleeve.

Paragraph 47. A cable management system for an electric vehicle charger, the cable management system comprising: a base structured to be coupled to a ceiling of a structure; a support column coupled to and extending downward from the base; an arm rotatably coupled to the support column and extending at least approximately horizontally outward from the support column; and a charger mount coupled to at least one of the base or the support column.

Paragraph 48. An electric vehicle charging system comprising: a cable management system comprising: a base coupled to a ceiling of a structure; a support column coupled to and extending downward from the base; an arm rotatably coupled to the support column and extending at least approximately horizontally outward from the support column; and a charger mount coupled to at least one of the base or the support column; and an electric vehicle charger coupled to the charger mount, the electric vehicle charger comprising: a charge cable coupled to and routed along the support column and the arm; and a charger plug hanging from a distal end of the arm.

Paragraph 49. A cable management system for an electric vehicle charger, the cable management system comprising: a base structured to be coupled to a ceiling of a structure; a support column coupled to and extending downward from the base, the support column having an adjustable length; and an arm rotatably coupled to the support column and extending horizontally or approximately horizontally outward from the support column.

Paragraph 50. The cable management system of Paragraph 45 wherein the length of the support column is adjustable telescopically.

Paragraph 51. The cable management system of Paragraph 45 wherein the support column comprises: a proximal extension coupled to the base; and a distal extension coupled to the arm; wherein the proximal extension and the distal extension are coupled together telescopically.

Paragraph 52. The cable management system of Paragraph 47 wherein: the proximal extension includes holes in a repeating pattern along the length of the proximal extension; the distal extension includes holes in a repeating pattern along a length of the distal extension; and the holes in the proximal extension and the holes in the distal extension are structured to be aligned in various configurations to adjust the length of the support column.

Paragraph 53. The cable management system of Paragraph 45 wherein the length of the support column is adjustable from approximately 3 in to approximately 72 in.

Paragraph 54. An electric vehicle charging system comprising: a cable management system comprising: a base coupled to a ceiling of a structure; a support column coupled to and extending downward from the base, the support column having an adjustable length; and an arm rotatably coupled to the support column and extending horizontally or approximately horizontally outward from the support column; and an electric vehicle charger comprising: a charge cable coupled to and routed along the support column and the arm; and a charger plug hanging from a distal end of the arm.

Paragraph 55. The electric vehicle charging system of Paragraph 50 wherein the length of the support column is adjustable telescopically.

Paragraph 56. The electric vehicle charging system of Paragraph 50 wherein the support column comprises: a proximal extension coupled to the base; and a distal extension coupled to the arm; wherein the proximal extension and the distal extension are coupled together telescopically.

Paragraph 57. The electric vehicle charging system of Paragraph 52 wherein: the proximal extension includes holes in a repeating pattern along the length of the proximal extension; the distal extension includes holes in a repeating pattern along a length of the distal extension; and the holes in the proximal extension and the holes in the distal extension are structured to be aligned in various configurations to adjust the length of the support column.

Paragraph 58. The electric vehicle charging system of Paragraph 50 wherein the length of the support column is adjustable from approximately 3 in to approximately 72 in.

Paragraph 59. A cable management system for an electric vehicle charger, the cable management system comprising: a base structured to be coupled to a ceiling of a structure; a support column coupled to and extending downward from the base, the support column including a rotation stop; and an arm rotatably coupled to the support column, the arm including a rotation limiter; wherein the rotation limiter contacts the rotation stop to limit rotation of the arm; and wherein the rotation limiter and the rotation stop are covered.

Paragraph 60. The cable management system of Paragraph 55 wherein the support column includes a pivot shaft adapter that covers the rotation limiter and the rotation stop.

Paragraph 61. An electric vehicle charging system comprising: a cable management system comprising: a base coupled to a ceiling of a structure; a support column coupled to and extending downward from the base, the support column including a rotation stop; and an arm rotatably coupled to the support column, the arm including a rotation limiter; and an electric vehicle charger comprising: a charge cable coupled to and routed along the support column and the arm; and a charger plug hanging from a distal end of the arm; wherein the rotation limiter contacts the rotation stop to limit rotation of the arm; and wherein the rotation limiter and the rotation stop are covered.

Paragraph 62. The electric vehicle charging system of Paragraph 57 wherein the support column includes a pivot shaft adapter that covers the rotation limiter and the rotation stop.

Paragraph 63. A cable management system for an electric vehicle charger, the cable management system comprising: a base structured to be coupled to a ceiling of a structure; a support column coupled to and extending downward from the base; an arm rotatably coupled to the support column and extending horizontally or approximately horizontally outward from the support column; and a rotation restrictor mechanism that restricts rotation of the arm relative to the support column; wherein the rotation restrictor mechanism allows the arm to rotate more than 360 degrees relative to the support column.

Paragraph 64. An electric vehicle charging system comprising: a cable management system comprising: a base coupled to a ceiling of a structure; a support column coupled to and extending downward from the base; an arm rotatably coupled to the support column and extending horizontally or approximately horizontally outward from the support column; and a rotation restrictor mechanism that restricts rotation of the arm relative to the support column; and an electric vehicle charger comprising: a charge cable coupled to and routed along the support column and the arm; and a charger plug hanging from a distal end of the arm; wherein the rotation restrictor mechanism allows the arm to rotate more than 360 degrees relative to the support column.

Paragraph 65. A cable management system for an electric vehicle charger, the cable management system comprising: a base structured to be coupled to a ceiling of a structure; a support column coupled to and extending downward from the base; an arm rotatably coupled to the support column and extending horizontally or approximately horizontally outward from the support column; and a rotation restrictor mechanism comprising a rotation limiter; wherein the rotation limiter moves relative to the arm and the support column to restrict rotation of the arm relative to the support column.

Paragraph 66. The cable management system of Paragraph 61 wherein the rotation restrictor mechanism comprises: a first rotation stop on the support column; and a second rotation stop on the arm; wherein the rotation limiter restricts rotation of the arm by contacting at least one of the first rotation stop or the second rotation stop.

Paragraph 67. An electric vehicle charging system comprising: a cable management system comprising: a base coupled to a ceiling of a structure; a support column coupled to and extending downward from the base; an arm rotatably coupled to the support column and extending horizontally or approximately horizontally outward from the support column; and a rotation restrictor mechanism comprising a rotation limiter; and an electric vehicle charger comprising: a charge cable coupled to and routed along the support column and the arm; and a charger plug hanging from a distal end of the arm; wherein the rotation limiter moves relative to the arm and the support column to restrict rotation of the arm relative to the support column.

Paragraph 68. The electric vehicle charging system of Paragraph 63 wherein the rotation restrictor mechanism comprises: a first rotation stop on the support column; and a second rotation stop on the arm; wherein the rotation limiter restricts rotation of the arm by contacting at least one of the first rotation stop or the second rotation stop.

Paragraph 69. A cable management system for an electric vehicle charger, the cable management system comprising: a base structured to be coupled to a ceiling of a structure; a support column coupled to and extending downward from the base; an arm rotatably coupled to the support column and extending at least approximately horizontally outward from the support column; and a motorized retractor coupled to the arm, the motorized retractor being configured to move a charge plug of the electric vehicle charger from a lowered position to a raised position.

Paragraph 70. An electric vehicle charging system comprising: a cable management system comprising: a base coupled to a ceiling of a structure; a support column coupled to and extending downward from the base; an arm rotatably coupled to the support column and extending at least approximately horizontally outward from the support column; and a motorized retractor coupled to the arm; and an electric vehicle charger comprising: a charge cable coupled to and routed along the support column and the arm; and a charger plug hanging from a distal end of the arm; wherein the motorized retractor is configured to move the charger plug from a lowered position to a raised position.

Paragraph 71. A cable management system for an electric vehicle charger, the cable management system comprising: a base structured to be coupled to a ceiling of a structure; a support column coupled to and extending downward from the base, the support column including a pivot shaft; and an arm rotatably coupled to the support column, the arm including a pivot sleeve; wherein the pivot shaft is structured to be inserted upward through the pivot sleeve.

Paragraph 72. The cable management system of Paragraph 67 wherein the pivot shaft is coupled to a distal end of the support column.

Paragraph 73. An electric vehicle charging system comprising: a cable management system comprising: a base coupled to a ceiling of a structure; a support column coupled to and extending downward from the base, the support column including a pivot shaft; and an arm rotatably coupled to the support column, the arm including a pivot sleeve; and an electric vehicle charger comprising: a charge cable coupled to and routed along the support column and the arm; and a charger plug hanging from a distal end of the arm; wherein the pivot shaft is structured to be inserted upward through the pivot sleeve.

Paragraph 74. The electric vehicle charging system of Paragraph 69 wherein the pivot shaft is coupled to a distal end of the support column.

Paragraph 75. A cable management system for an electric vehicle charger, the cable management system comprising: a base structured to be coupled to a ceiling of a structure, the base including at least three sets of mounting holes; a support column coupled to and extending downward from the base; and an arm rolatably coupled to the support column and extending horizontally or approximately horizontally outward from the support column; wherein the at least three sets of mounting holes are spaced apart to accommodate at least three different spacings for studs in the ceiling.

Paragraph 76. An electric vehicle charging system comprising: a cable management system comprising: a base coupled to a ceiling of a structure, the base including at least three sets of mounting holes; a support column coupled to and extending downward from the base; and an arm rotatably coupled to the support column and extending horizontally or approximately horizontally outward from the support column; and an electric vehicle charger comprising: a charge cable coupled to and routed along the support column and the arm; and a charger plug hanging from a distal end of the arm; wherein the at least three sets of mounting holes are spaced apart to accommodate at least three different spacings for studs in the ceiling.

Paragraph 77. The cable management system or electric vehicle charging system of any of the preceding Paragraphs wherein the structure is a garage comprising at least two garage doors, and wherein the cable management system is coupled to the ceiling at a location between the at least two garage doors.

Paragraph 78. The cable management system or electric vehicle charging system of any of the preceding Paragraphs wherein the structure is a garage comprising at least one double garage door, and wherein the cable management system is coupled to the ceiling at a location approximately in the middle of the double garage door.

Paragraph 79. A cable management system for an electric vehicle charger, the cable management system comprising: a base structured to be coupled to a wall of a structure; and an arm rotatably coupled to the base and extending outward horizontally or approximately horizontally from the base; wherein the arm is slidably coupled to the base.

Paragraph 80. An electric vehicle charging system comprising: a cable management system comprising: a base coupled to a wall of a structure; and an arm rotatably coupled to the base and extending outward horizontally or approximately horizontally from the base; and an electric vehicle charger comprising: a charge cable coupled to and routed along the arm; and a charger plug hanging from a distal end of the arm; wherein the arm is slidably coupled to the base.

Paragraph 81. A cable management system for an electric vehicle charger, the cable management system comprising: a base structured to be coupled to a wall of a structure; and an arm rotatably coupled to the base, the arm comprising: a beam extending horizontally or approximately horizontally outward from the base, the beam being structured to rotate downward relative to the wall; and a spring coupled to the beam, the spring being structured to hold the beam horizontally or approximately horizontally.

Paragraph 82. The cable management system of Paragraph 77 wherein the arm includes at least two springs coupled to the beam and structured to hold the beam horizontally or approximately horizontally.

Paragraph 83. The cable management system of Paragraph 77 wherein the spring is a mechanical spring.

Paragraph 84. The cable management system of Paragraph 77 wherein the spring is a gas spring.

Paragraph 85. The cable management system of Paragraph 77 wherein the beam applies a tension force to the spring.

Paragraph 86. The cable management system of Paragraph 77 wherein the beam applies a compression force to the spring.

Paragraph 87. The cable management system of Paragraph 77 wherein the arm comprises an overload mechanism that includes the spring, and wherein the overload mechanism is capable of being selectively configured between a first configuration where the beam applies a tension force to the spring and a second configuration where the beam applies a compression force to the spring.

Paragraph 88. The cable management system of Paragraph 77 wherein the arm includes a pivot sleeve rotatably coupled to the base, wherein the beam is rotatably coupled to the pivot sleeve in a manner that allows the beam to rotate downward relative to the base, and wherein the spring is coupled to the pivot sleeve and extends upward or downward at an angle relative to the base.

Paragraph 89. The cable management system of Paragraph 77 wherein the arm is structured to rotate downward at least five degrees relative to the base.

Paragraph 90. The cable management system of Paragraph 77 wherein the arm includes a pivot sleeve, and wherein the arm is structured to allow the beam to be coupled to the top of the pivot sleeve or the bottom of the pivot sleeve.

Paragraph 91. An electric vehicle charging system comprising: a cable management system comprising: a base coupled to a wall of a structure; and an arm rotatably coupled to the base, the arm comprising: a beam extending horizontally or approximately horizontally outward from the base, the beam being structured to rotate downward relative to the wall; and a spring coupled to the beam, the spring being structured to hold the beam horizontally or approximately horizontally; and an electric vehicle charger comprising: a charge cable coupled to and routed along the arm; and a charger plug hanging from a distal end of the arm.

Paragraph 92. The electric vehicle charging system of Paragraph 87 wherein the arm includes at least two springs coupled to the beam and structured to hold the beam horizontally or approximately horizontally.

Paragraph 93. The electric vehicle charging system of Paragraph 87 wherein the spring is a mechanical spring.

Paragraph 94. The electric vehicle charging system of Paragraph 87 wherein the spring is a gas spring.

Paragraph 95. The electric vehicle charging system of Paragraph 87 wherein the beam applies a tension force to the spring.

Paragraph 96. The electric vehicle charging system of Paragraph 87 wherein the beam applies a compression force to the spring.

Paragraph 97. The electric vehicle charging system of Paragraph 87 wherein the arm comprises an overload mechanism that includes the spring, and wherein the overload mechanism is capable of being selectively configured between a first configuration where the beam applies a tension force to the spring and a second configuration where the beam applies a compression force to the spring.

Paragraph 98. The electric vehicle charging system of Paragraph 87 wherein the arm includes a pivot sleeve rotatably coupled to the base, wherein the beam is rotatably coupled to the pivot sleeve in a manner that allows the beam to rotate downward relative to the base, and wherein the spring is coupled to the pivot sleeve and extends upward or downward at an angle relative to the beam.

Paragraph 99. The electric vehicle charging system of Paragraph 87 wherein the arm is structured to rotate downward at least five degrees relative to the base.

Paragraph 100. The electric vehicle charging system of Paragraph 87 wherein the arm includes a pivot sleeve, and wherein the arm is structured to allow the beam to be coupled to the top of the pivot sleeve or the bottom of the pivot sleeve.

Paragraph 101. A cable management system for an electric vehicle charger, the cable management system comprising: a base structured to be coupled to a wall of a structure; a first arm coupled to and extending outward from the base, the first arm being fixed in position; a support column coupled to the first arm, the support column having an upright orientation; and a second arm rotatably coupled to the support column.

Paragraph 102. An electric vehicle charging system comprising: a cable management system comprising: a base coupled to a wall of a structure; a first arm coupled to and extending outward from the base, the first arm being fixed in position; a support column coupled to the first arm, the support column having an upright orientation; and a second arm rotatably coupled to the support column; an electric vehicle charger comprising: a charge cable coupled to and routed along the support column and the second arm; and a charger plug hanging from a distal end of the second arm.

Paragraph 103. A cable management system for an electric vehicle charger, the cable management system comprising: a base structured to be coupled to a wall of a structure; an arm rotatably coupled to the base and extending outward horizontally or approximately horizontally from the base; and a charger mount coupled to the base.

Paragraph 104. An electric vehicle charging system comprising: a cable management system comprising: a base coupled to a wall of a structure; an arm rotatably coupled to the base and extending outward horizontally or approximately horizontally from the base; and a charger mount coupled to the base; and an electric vehicle charger coupled to the charger mount, the electric vehicle charger comprising: a charge cable coupled to and routed along the arm; and a charger plug hanging from a distal end of the arm.

Paragraph 105. The cable management system or electric vehicle charging system of any of the preceding Paragraphs 1 wherein the structure is a garage.

Paragraph 106. The cable management system or electric vehicle charging system of any of the preceding Paragraphs wherein the structure is a garage comprising at least one garage door, and wherein the at least one garage door moves between a vertical position where the at least one garage door is closed and a horizontal position above a parking space where the at least one garage door is open.

Paragraph 107. The cable management system or electric vehicle charging system of any of the preceding Paragraphs wherein the base includes mounting holes and the mounting holes are elongated.

Paragraph 108. The cable management system or electric vehicle charging system of Paragraph 103 wherein the mounting holes are elongated in a lengthwise direction of the base.

Paragraph 109. The cable management system or electric vehicle charging system of any of the preceding Paragraphs wherein the base includes at least three sets of mounting holes that are spaced apart to accommodate stud spacings of approximately 12 in, approximately 16 in, and approximately 24 in.

Paragraph 110. The cable management system or electric vehicle charging system of any of the preceding Paragraphs wherein the length of the arm is approximately 3 ft to approximately 12 ft.

Paragraph 111. The cable management system or electric vehicle charging system of any of the preceding Paragraphs wherein the arm comprises a proximal beam rotatably coupled to a distal beam, and the length of each of the proximal beam and the distal beam is approximately 1 ft to approximately 8 ft.

Paragraph 112. The cable management system or electric vehicle charging system of any of the preceding Paragraphs wherein the arm comprises a proximal beam rotatably coupled to a distal beam, and wherein the proximal beam and the distal beam are in the same plane.

Paragraph 113. The cable management system or electric vehicle charging system of any of the preceding Paragraphs wherein the arm comprises a proximal beam rotatably coupled to a distal beam, and wherein the proximal beam has a larger cross-section than the distal beam.

Paragraph 114. The cable management system or electric vehicle charging system of any of the preceding Paragraphs wherein: the arm comprises: a pivot sleeve rotatably coupled to the support column; and a beam coupled to and extending horizontally or approximately horizontally outward from the pivot sleeve; wherein the beam can be selectively coupled to either the top or the bottom of the pivot sleeve.

Paragraph 115. The cable management system or electric vehicle charging system of any of the preceding Paragraphs comprising a charger mount structured to be coupled to the ceiling of the structure.

Paragraph 116. The cable management system or electric vehicle charging system of any of the preceding Paragraphs comprising a charger mount structured to be coupled to the base.

Paragraph 117. The cable management system or electric vehicle charging system of any of the preceding Paragraphs comprising a charger mount structured to be coupled to the support column.

Paragraph 118. The cable management system or electric vehicle charging system of any of the preceding Paragraphs comprising charger mount structured to be coupled to a variety of electric vehicle chargers.

Paragraph 119. The cable management system or electric vehicle charging system of any of the preceding Paragraphs comprising a charger mount including a first mount rail and a second mount rail coupled to the first mount rail, the second mount rail being positioned transverse to the first mount rail.

Paragraph 120. The cable management system or electric vehicle charging system of Paragraph 115 wherein the charger mount comprising a third mount rail coupled to the first mount rail and positioned transverse to the first mount rail.

Paragraph 121. The cable management system or electric vehicle charging system of any of Paragraphs 115 to 116 wherein the first mount rail is structured to allow the second mount rail to be coupled at multiple lengthwise locations along the first mount rail.

Paragraph 122. The cable management system or electric vehicle charging system of any of Paragraphs 115 to 117 wherein the first mount rail and/or the second mount rail include at least one mounting slot to which the electric vehicle charger can be coupled.

Paragraph 123. The cable management system or electric vehicle charging system of any of the preceding Paragraphs comprising a charger mount structured to be coupled first to the electric vehicle charger and then to the cable management system.

Paragraph 124. The cable management system or electric vehicle charging system of any of the preceding Paragraphs wherein a charge cable of the electric vehicle charger is coupled to the top of the arm.

Paragraph 125. The cable management system or electric vehicle charging system of any of the preceding Paragraphs wherein a charge cable of the electric vehicle charger is coupled to the arm with cable ties.

Paragraph 126. The cable management system or electric vehicle charging system of any of the preceding Paragraphs wherein the arm includes cable tie holders to which a charge cable of the electric vehicle charger can be coupled with cable ties.

Paragraph 127. A structure comprising the cable management systems and/or the electric vehicle charging systems of any of the preceding Paragraphs coupled to the ceiling and/or wall of the structure.

Paragraph 128. The structure of Paragraph 123 wherein the structure is a garage.

Paragraph 129. The structure of Paragraph 124 wherein the garage is a residential garage.

### Electronic Computing Device

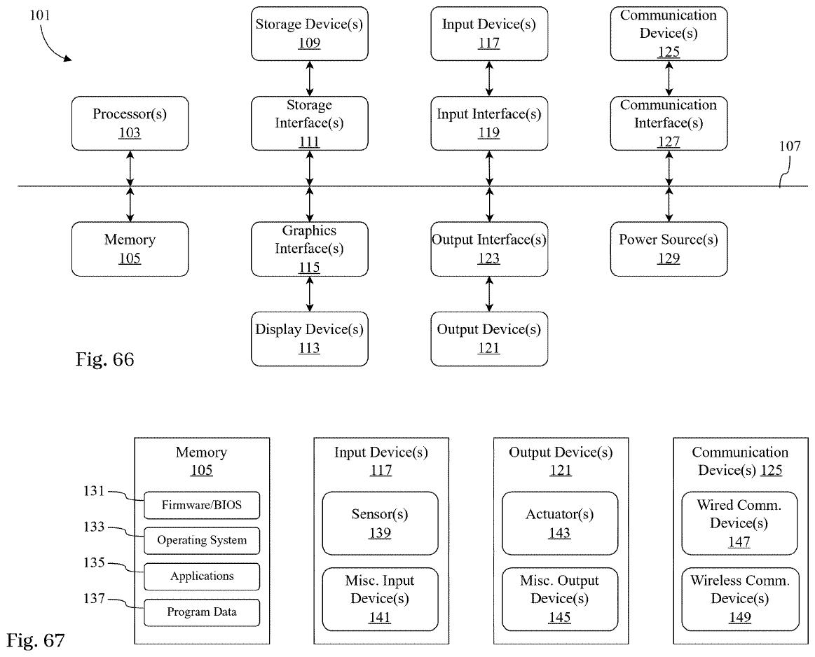

FIG. 66 shows one embodiment of an electronic computing device 101 (alternatively referred to as an electronic controller, programmable logic controller, electronic control system, or electronic computing system) that can be used as part of the system used to control the motorized cable management system. FIG. 67 shows embodiments of the devices that can be included as part of the electronic computing device 101.

The electronic computing device 101 includes one or more processors 103 (alternatively referred to as a digital processing unit or microprocessor) and memory 105 communicatively linked to each other by way of a system bus 107. In some embodiments, the electronic computing device 101 can also include one or more other interfaces and/or devices communicatively linked to the system bus 107.

For example, one or more storage devices 109 can be communicatively linked to the system bus 107 by way of one or more storage interfaces 111. One or more display devices 113 can be communicatively linked to the system bus 107 by way of one or more graphics interfaces 115. One or more input devices 117 can be communicatively linked to the system bus 107 by way of one or more input interfaces 119. One or more output devices 121 can be communicatively linked to the system bus 107 by way of one or more output interfaces 123. One or more communication devices 125 can be communicatively linked to the system bus 107 by way of one or more communication interfaces 127.

It should be appreciated that the electronic computing device 101 can have a variety of configurations. For example, in some embodiments, the various components of the electronic computing device 101 can be positioned near each other in one or more housings and on a single circuit board or multiple circuit boards communicatively linked together, or the like. In other embodiments, the various components of the electronic computing device 101 can be located remotely. For example, the one or more input devices 117 and/or the one or more output devices 121 can be located remotely or at a distance from the one or more processors 103 and/or the memory 105.

### Processor

Each of the one or more processors 103 is an electric circuit such as an integrated circuit that executes program instructions. The processor 103 can perform operations such as arithmetic operations, logic operations, controlling operations, and input/output (I/O) operations specified by the program instructions. In some embodiments, the processor 103 includes a control unit (CU), an arithmetic logic unit (ALU), and/or a memory unit (alternatively referred to as cache memory).

The control unit can direct the operation of the processor 103 and/or instruct the memory 105, arithmetic logic unit, and output devices 121 how to respond to instructions in the program. It can also direct the flow of data or information between the processor 103 and other components of the electronic computing device 101. It can also control the operation of other components by providing timing and control signals.

The arithmetic logic unit is an electric circuit in the processor 103 that performs integer arithmetic and bitwise logic operations. The arithmetic logic unit receives input in the form of data or information to be operated on and code describing the operation to be performed. The arithmetic logic unit provides the result of the performed operation as output. In some configurations, the arithmetic logic unit can also include status inputs and/or outputs that convey information about a previous operation or the current operation between the arithmetic logic unit and external status registers.

It should be appreciated that the processor 103 can have any suitable configuration. For example, the processor 103 can range from a simple processor specially built or configured to execute one or more programs for a specific application or device to a complex central processing unit configured to be used in a wide variety of ways and an equally wide variety of applications. Examples of processors 103 include a general-purpose processor, a digital signal processor (DSP), an application specific integrated circuit (ASIC), a central processing unit (CPU), a field programmable gate array (FPGA) or other programmable logic device (PLD), and/or discrete gate or transistor logic. The processor 103 can also be implemented as any one or combination of these devices.

### Memory

The memory 105 (alternatively referred to as primary memory, main memory, or a computer-readable medium) is a semiconductor device or system used to store information for immediate use by the processor 103. The memory 105 is generally directly accessible to the processor 103. The processor 103 can read and execute program instructions stored in the memory 105 as well as store data and/or other information in the memory 105 that is actively being operated on. The memory 105 is generally more expensive and operates at higher speeds compared to the storage device 109. The memory 105 can be volatile such as random-access memory (RAM) or non-volatile such as read-only memory (ROM).

### System Bus

The system bus 107 broadly refers to the communication system through which information is transferred between the processor 103, the memory 105, and/or other components such as peripherals that can be considered part of the electronic computing device 101. The system bus 107 can include a physical system of connectors, conductive pathways, optical pathways, wires, or the like through which information travels.

The system bus 107 can have a variety of physical configurations. In some embodiments, the system bus can be configured as a backbone connecting the processor 103, the memory 105, and/or the various devices and/or interfaces as shown in the figure. In other embodiments, the system bus 107 can be configured as separate buses that communicatively link one or more components together. For example, the system bus 107 can include a bus communicatively linking the processor 103, the memory 105, and/or circuit board (the bus can alternatively be referred to as the front-side bus, memory bus, local bus, or host bus). The system bus 107 can include multiple additional I/O buses communicatively linking the various other devices and/or interfaces to the processor 103.

It should be appreciated that information shared between the components of the electronic computing device 101 can include program instructions, data, signals such as control signals, commands, bits, symbols, or the like. The information can be represented using a variety of different technologies and techniques. For example, in some embodiments, the information can be represented by voltages, currents, electromagnetic waves, magnetic fields or particles, optical fields, or the like.

The system bus 107 can also be used for other purposes besides sharing information. For example, the system bus 107 can be used to supply power from the power source 129 to the various devices and/or interfaces connected to the system bus 107. Likewise, the system bus 107 can include address lines which match those of the processor 103. This allows information to be sent to or from specific memory locations in the memory 105. The system bus 107 can also provide a system clock signal to synchronize the various devices and/or interfaces with the rest of the system.

The system bus 107 can use a variety of architectures, communication protocols, or protocol suites to communicatively link the processor 103, the memory 105, and/or any of the other devices and/or interfaces. For example, suitable architectures include Industry Standard Architecture (ISA), Extended Industry Standard Architecture (EISA), Micro Channel Architecture (MCA), Video Electronics Standards Association (VESA), Peripheral Component Interconnect (PCI), PCI Express (PCI-X), Personal Computer Memory Card Industry Association (PCMCIA or PC bus), Accelerated Graphics Port (AGP), Small Computer Systems Interface (SCSI), and the like. Suitable communication protocols include TCP/IP, IPX/SPX, Modbus, DNP, BACnet, ControlNet, Ethernet/IP, or the like.

### Program Instructions

The instructions stored in the electronic computing device 101 can include software algorithms and/or application programs. It should be appreciated that the software algorithms can be expressed in the form of methods or processes performed in part or entirely by the electronic computing device 101 or as instructions stored in a computer-readable medium such as the memory 105 and/or the storage device 109. Likewise, the software algorithms are shown in the flowcharts and described in the methods and/or processes.

It should be appreciated that instructions can take the form of entirely software (including firmware, resident software, micro-code, or the like), entirely hardware, or a combination of software and hardware. If implemented in software executed by the processor 103, the information may be stored on or transmitted over a computer-readable medium such as the memory 105 and/or the storage device 109. In some embodiments, the instructions can be contained in any tangible medium of expression having program code embodied in the medium. In some embodiments, the instructions can be written in any combination of one or more programming languages, which can be text-based or graphical languages.

It should also be appreciated that the flowcharts, block diagrams, methods, and/or processes describe algorithms and/or symbolic representations of information operations. The algorithmic descriptions and representations are the means used by those skilled in the data processing arts to convey the substance of their work most effectively to others skilled in the art. These operations, while described functionally or logically, are understood to be implemented by software and/or hardware that can be readily and easily created from the functional or logical descriptions of the algorithms.

For example, the instructions can include an algorithm for making a decision—e.g., determining whether a parameter satisfies one or more conditions and performing various operations based upon the parameter satisfying the one or more conditions. This can be represented in the instructions with a conditional statement or condition expression written in a programming language. An example of such a conditional is shown below. It should be appreciated that the syntax for the conditional will vary depending on the chosen programming language.

```
if condition1satisfied then
  perform operation 1
elseif condition2satisfied then
  perform operation 2
elseif condition3satisfied then
  perform operation 3
else
  perform operation 4;
end if;
```

The instructions can be used to perform a variety of operations. For example, the instructions can be used to control the receipt and processing of data from the input devices 117. The instructions can also be used to control hardware such as any of the output devices 121.

In some embodiments, the instructions can include firmware such as a basic input/output system (BIOS) 131, an operating system 133, one or more application programs 135, program data 137, and the like. These can be stored in the memory 105 and/or the storage device 109. In general, the instructions are stored in the memory 105 when the electronic computing device 101 is on and running or while the instructions are being used (e.g., an application program is running). Likewise, the instructions are stored in the storage device 109 when the electronic computing device 101 is off.

In some embodiments, the instructions are used to control the operation of the motor 300.

### Storage Device

Each of the one or more storage devices 109 (alternatively referred to as secondary memory, or a computer-readable medium) is a device or system used to store information that is not needed for immediate use by the processor 103. The storage device 109 can be communicatively linked to the system bus 107 by way of a storage interface 111. The storage device 109 is generally not directly accessible to the processor 103. The storage device 109 is generally less expensive and operates at lower speeds compared to the memory 105. The storage device 109 is also generally non-volatile and used to permanently store the information.

The storage device 109 can take a variety of physical forms and use a variety of storage technologies. For example, in some embodiments, the storage device 109 can be in the form of a hard disk storage device, solid-state storage device, optical storage device, or the like. Also, in some embodiments, the storage device 109 can use technologies such as a magnetic disk (e.g., disk drives), laser beam (e.g., optical drives), semiconductor (e.g., solid-state drives), and/or magnetic tape to store information.

### Display Device

Each of the one or more display devices 113 (alternatively referred to as a human-machine interfaces (HMI) or screens) is a device that visually conveys text, graphics, video, and/or other information. In some embodiments, the information shown on the display device 113 exists electronically and is displayed for a temporary period of time. It should be appreciated that the display device 113 can operate as an output device and/or input device (e.g., touchscreen display or the like).

The display device 113 can be communicatively linked to the system bus 107 by way of one or more graphics interfaces 115. In some embodiments, the graphics interface 115 can be used to generate a feed of output images to the display device 113. In some embodiments, the graphics interface 115 can be a separate component such as a dedicated graphics card or chip or can be an integrated component that is part of or a subset of the processor 103.

It should be appreciated that the display device 113 can include a variety of physical structures and/or display technologies. For example, in some embodiments, the display device 113 can be a screen integrated into a specific application or technology, a separate screen such as a monitor, or the like. The display device 113 can also be a liquid crystal display, a light emitting diode display, a plasma display, a quantum dot display, or the like.

### Input Devices

Each of the one or more input devices 117 is a physical component that provides information to the processor 103 and/or the memory 105. The input device 117 can be communicatively linked to the system bus 107 by way of one or more input interfaces 119. The input device 117 can be any suitable type and can provide any of a variety of information. For example, the input device 117 can be a digital and/or analog device and can provide information in a digital or analog format. Also, the input device 117 can be used to provide user input for controlling the electronic computing device 101 or operational input for controlling aspects of a specific application.

The input device 117 can include one or more sensors 139 and/or one or more other miscellaneous input devices 141. It should be appreciated that the input device 117 is not limited to only providing information. In some embodiments, the input device 117 can also receive information. Such devices can be considered both an input device 117 and an output device 121.

The miscellaneous input device 141 can include a variety of devices or components. In some embodiments, the miscellaneous input devices 141 can include switches such as limit switches, level switches, vacuum switches, pressure switches, or the like, as well as buttons including pushbuttons or the like. In some embodiments, the miscellaneous input devices 141 include user interface components such as a pointing device, for example a mouse, text input devices, for example a keyboard, a touch screen, or the like.

### Sensors

Each of the one or more sensors 139 can be used to provide information about a wide variety of measured parameters. In general terms, the sensor 139 is used to measure or detect information about its environment and send the information to the processor 103 and/or the memory 105. In some embodiments, the sensor 139 can operate as a transducer and generate an electrical signal as a function of the measured parameter. The electrical signal is communicated to the processor 103 and/or the memory 105 where it can be used for a variety of purposes.

The sensor 139 can be a digital sensor and/or an analog sensor. For example, in some embodiments, the sensor 139 provides digital information to the processor 103 and/or the memory 105. In other embodiments, the sensor 139 provides analog information to the processor 103 and/or the memory 105. Also, in some embodiments, the information can be converted from one type to the other—e.g., from digital to analog or from analog to digital.

The sensor 139 can measure the parameter directly (i.e., direct measurement) or indirectly (i.e., indirect measurement). A direct measurement sensor directly measures the parameter itself. An indirect measurement sensor measures a secondary parameter that can be translated into the parameter of interest.

The sensor 139 can communicate information to the processor 103 and/or the memory 105 in a variety of ways and/or using a variety of protocols. In some embodiments, the sensor 139 can be a protocol-based sensor that uses a protocol to communicate with the processor 103 and/or the memory 105, or it can be a nonprotocol-based sensor that does not use a protocol to communicate with the processor 103 and/or the memory 105. A protocol-based sensor communicates with the processor 103 by sending a data stream by way of a communication protocol. In some embodiments, the protocol-based sensor includes a separate processor that is part of the sensor and used to communicate using the protocol.

It should be appreciated that the information provided by the sensor 139 can be used in a variety of ways by the processor 103. For example, in some embodiments, the processor 103 can compare the information to a set point. In some embodiments, analog information is amplified before being compared to the set point.

In some embodiments, the sensor 139 can be used to measure one or more parameters. For example, the sensors 139 can be used to measure the position of the charge plug 112 or the like.

### Position Sensors

In some embodiments, the sensor 139 is a position sensor configured to measure the position of the charge plug 112. The position sensor can be used to determine the absolute position or location of the component or the relative position or displacement of the component in terms of linear travel, rotational angle, or three-dimensional space. In some embodiments, the position sensor acts as a transducer and generates an electrical signal as a function of the measured position.

The position sensor can be a contact type position sensor or a non-contact type position sensor. Contact type position sensors are positioned in physical contact with the component to detect changes in its position. Non-contact type position sensors can detect changes in the position of the component without being in physical contact with it.

The position sensor can be any of a variety of types of position sensors and can be used to measure a variety of positions or movements including linear, rotary, and/or angular positions or movements. For example, suitable position sensors include potentiometric position sensors, inductive position sensors such as a linear variable differential transformer or a rotary variable differential transformer, eddy current-based position sensors, capacitive position sensors, magnetostrictive position sensors, hall effect-based magnetic position sensors, fiber optic position sensors, optical position sensors, ultrasonic position sensors, or the like.

### Output Devices

Each of the one or more output devices 121 is a physical component that receives information from the processor 103 and/or the memory 105. The output device 121 can be communicatively linked to the system bus 107 by way of one or more output interfaces 123. The output device 121 can be any suitable type and can receive any of a variety of information. For example, the output device 121 can be a digital and/or analog device and can receive information in a digital and/or analog format. Also, the output device 121 can be used to provide information to the user or perform various operations related to the specific application.

The output device 121 can include one or more actuators 143 and/or one or more other miscellaneous output devices 145. It should be appreciated that the output device 121 is not limited to only receiving information. In some embodiments, the output device 121 can also send information. Such devices can be considered both an output device 121 and an input device 117.

The miscellaneous output devices 145 can include a variety of devices or components. In some embodiments, the miscellaneous output devices 145 can include audio output devices such as speakers as well as other output devices.

### Actuators

Each of the one or more actuators 143 can be used to activate movement or an operation. In general terms, the actuator 143 is used to activate something in response to an instruction or control signal sent from the processor 103. In some embodiments, the actuator 143 can act as a transducer by receiving an electrical signal and transforming it into the desired movement or operation.

The information received by the actuator 143 can take a variety of forms and use a number of technologies. For example, the information may be in the form of an electric voltage or current, pneumatic or hydraulic fluid pressure, binary data, or the like. The information can be provided as digital and/or analog format. For example, in some embodiments, the actuator 143 receives digital information from the processor 103 or other component(s) in the electronic computing device 101. In other embodiments, the actuator 143 receives analog information from the processor 103 or other component(s) in the electronic computing device 101. Also, in some embodiments, the information received by the actuator 143 can be converted from one type to the other—e.g., from digital to analog or from analog to digital.

The actuator 143 can use a variety of energy sources to operate. For example, the actuator 143 can operate using electrical energy, hydraulic energy, pneumatic energy, thermal energy, magnetic energy, or the like. Likewise, the actuator 143 can be an electric actuator, hydraulic actuator, pneumatic actuator, thermal actuator, magnetic actuator, or the like. The actuator 143 can also be used to produce a variety of movements. For example, the actuator 143 can be used to produce linear movement and/or rotary movement.

### Motors

In some embodiments, the actuator 143 can include an electric motor. In general, the electric motor is a device that converts electrical energy to mechanical energy. In some embodiments, the mechanical energy produced by the electric motor is in the form of the rotation of a shaft. The mechanical energy can be used directly or converted into other mechanical movement using levers, gears, ratchets, cams, or the like. The motor can be a DC motor or an AC motor.

### Relays

In some embodiments, the actuator 143 can include a relay. In general, a relay is an electrically operated switch. In some embodiments, the relay includes one or more input terminals to receive information or control signals and one or more operating contact terminals electrically linked to a separate electrical device.

In some embodiments, the relays can include electromechanical relays having contacts that mechanically open and close. For example, the relay can include an electromagnet that opens and closes the contacts. In other embodiments, the relays can include solid state relays that use semiconductor properties to control the on or off state of the relay without any moving parts. Solid state relays can include thyristors and transistors to switch currents up to a hundred amps or more.

### Communication Devices

Each of the communication devices 125 is a physical component that allows the electronic computing device 101 to communicate with other devices, components, and/or networks. The communication device can be communicatively linked to the system bus 107 by way of one or more communication interfaces 127. The communication device 125 can include one or more wired communication devices 147 and/or one or more wireless communication devices 149.

It should be appreciated that the communication device 125 can be any suitable physical device. For example, in some embodiments, the communication device 125 is a network interface controller used to connect the electronic computing device 101 to a larger network such as a local area network (LAN), wide area network (WAN), or the Internet.

It should also be appreciated that the communication device 125 can use a variety of communication protocols. For example, in some embodiments, the wired communication device 147 can use communication protocols such as Ethernet, RS-232, RS-485, USB, or the like. Also, in some embodiments, the wireless communication devices 149 can use communication protocols such as Wi-Fi, Bluetooth, Zigbee, LTE, 5G, or the like.

### Power Source

The power source 129 can be used to supply electric power to the electronic computing device 101. The power source 129 can provide any suitable type of power including AC power, DC power, or the like. The power source 129 can obtain power from any suitable source including an AC power source (standard wall outlet), DC power source (a transformer plugged into a wall outlet), battery, generator, or the like.

In some embodiments, the power source 129 includes a power supply that converts electric current from a source to a desired voltage, current, and/or frequency to power the electronic computing device 101. In some embodiments, the power supply can convert AC power ranging from 110-240 VAC to DC power ranging from 6-60 VDC.

### Circuit Board

The electronic computing device 101 can include one or more circuit boards (alternatively referred to as logic boards) to which one or more of the components can be coupled. For example, the processor 103, the memory 105, the storage device 109, the display device 113, the input device 117, the output device 121, the communication device 125, and/or the power source 129 can be coupled to one or more circuit boards. In some embodiments, the processor 103, the memory 105, and/or the storage device 109 can be coupled to one circuit board.

In some embodiments, the circuit board can contain a series of conductive tracks, pads, and/or other features etched from one or more sheet layers of copper laminate laminated onto and/or between sheet layers of nonconductive substrate. The conductive features can be part of the system bus 107 communicatively linking the various components of the electronic computing device 101. In some embodiments, the circuit board can be a printed circuit board. In some embodiments, the circuit board can be a motherboard.

### General Terminology and Interpretative Conventions

Any methods described in the claims or specification should not be interpreted to require the steps to be performed in a specific order unless expressly stated otherwise or doing so is impossible. Also, the methods should be interpreted to provide support to perform the recited steps in any order unless expressly stated otherwise.

Certain features described in the context of separate embodiments can also be implemented in combination in a single embodiment. Conversely, various features described in the context of a single embodiment can also be implemented in multiple embodiments separately or in any suitable subcombination. Moreover, although features may be described in certain combinations and even initially claimed as such, one or more features from a claimed combination can be excised from the combination, and the claimed combination may be directed to a subcombination or variation of a subcombination.

The example configurations described in this document do not represent all the examples that may be implemented or that are within the scope of the claims. The term “example” shall be interpreted to mean “serving as an example, instance, or illustration,” and not “preferred” or “advantageous over other examples.”

Articles such as “the,” “a,” and “an” can connote the singular or plural. Also, the word “or” when used without a preceding “either” (or other similar language indicating that “or” is unequivocally meant to be exclusive—e.g., only one of x or y, etc.) shall be interpreted to be inclusive (e.g., “x or y” means one or both x or y).

The term “and/or” shall also be interpreted to be inclusive (e.g., “x and/or y” means one or both x or y). In situations where “and/or” or “or” are used as a conjunction for a group of three or more items, the group should be interpreted to include one item alone, all the items together, or any combination or number of the items.

The phrase “based on” shall be interpreted to refer to an open set of conditions unless unequivocally stated otherwise (e.g., based on only a given condition). For example, a step described as being based on a given condition may be based on the recited condition and one or more unrecited conditions.

The terms have, having, contain, containing, include, including, and characterized by should be interpreted to be synonymous with the terms comprise and comprising—i.e., the terms are inclusive or open-ended and do not exclude additional unrecited subject matter. The use of these terms should also be understood as disclosing and providing support for narrower alternative embodiments where these terms are replaced by “consisting of,” “consisting of the recited subject matter plus impurities and/or trace amounts of other materials,” or “consisting essentially of.”

Unless otherwise indicated, all numbers or expressions, such as those expressing dimensions, physical characteristics, or the like, used in the specification (other than the claims) are understood to be modified in all instances by the term “approximately.” At the very least, and not as an attempt to limit the application of the doctrine of equivalents to the claims, each numerical parameter recited in the specification or claims which is modified by the term “approximately” should be construed in light of the number of recited significant digits and/or by applying ordinary rounding techniques.

All disclosed ranges are to be understood to encompass and provide support for claims that recite any subranges or any individual values subsumed by each range. For example, a stated range of 1 to 10 should be considered to include and provide support for claims that recite any subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth), which values can be expressed alone or as a minimum value (e.g., at least 5.8) or a maximum value (e.g., no more than 9.9994).

All disclosed numerical values are to be understood as being variable from 0-100% in either direction and thus provide support for claims that recite such values (either alone or as a minimum or a maximum—e.g., at least <value> or no more than <value>) or any ranges or subranges that can be formed by such values. For example, a stated numerical value of 8 should be understood to vary from 0 to 16 (100% in either direction) and provide support for claims that recite the range itself (e.g., 0 to 16), any subrange within the range (e.g., 2 to 12.5) or any individual value within that range expressed individually (e.g., 15.2), as a minimum value (e.g., at least 4.3), or as a maximum value (e.g., no more than 12.4).

The terms recited in the claims should be given their ordinary and customary meaning as determined by reference to relevant entries in widely used general dictionaries and/or relevant technical dictionaries, commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used in a manner that is more expansive than its ordinary and customary meaning, the term should be given its ordinary and customary meaning plus the additional expansive meaning, or (b) if a term has been explicitly defined to have a different meaning by reciting the term followed by the phrase “as used in this document shall mean” or similar language (e.g., “this term means,” “this term is defined as,” “for the purposes of this disclosure this term shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained in this document should be considered a disclaimer or disavowal of claim scope.

None of the limitations in the claims should be interpreted as invoking 35 U.S.C. 112(f) unless the words “means for” or “step for” are explicitly recited in the claim.

Unless explicitly stated otherwise or otherwise apparent from context, terms such as “processing,” “computing,” “calculating,” “determining,” “displaying,” or the like, refer to the action and processes of an electronic computing device including a processor and memory.

The subject matter recited in the claims is not coextensive with and should not be interpreted to be coextensive with any embodiment, feature, or combination of features described or illustrated in this document. This is true even if only a single embodiment of the feature or combination of features is illustrated and described.

### Joining or Fastening Terminology and Interpretative Conventions

The term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature.

The term “coupled” includes joining that is permanent in nature or releasable and/or removable in nature. Permanent joining refers to joining the components together in a manner that is not capable of being reversed or returned to the original condition. Releasable joining refers to joining the components together in a manner that is capable of being reversed or returned to the original condition.

Releasable joining can be further categorized based on the difficulty of releasing the components and/or whether the components are released as part of their ordinary operation and/or use. Quickly releasable joining (i.e., quick-release) refers to joining that that can be released without the use of tools. Readily or easily releasable joining refers to joining that can be readily, easily, and/or promptly released with little or no difficulty or effort. Some joining can qualify as both quickly releasable joining and readily or easily releasable joining. Other joining can qualify as one of these types of joining but not the other. For example, one type of joining may be readily or easily releasable but also require the use of a tool.

Non-quickly releasable joining (i.e., non-quick-release) refers to joining that can only be released with the use of tools. Difficult or hard to release joining refers to joining that is difficult, hard, or arduous to release and/or requires substantial effort to release. Some joining can qualify as both non-quickly releasable joining and difficult or hard to release joining. Other joining can qualify as one of these types of joining but not the other. For example, one type of joining may require the use of a tool but may not be difficult or hard to release.

The joining can be released or intended to be released as part of the ordinary operation and/or use of the components or only in extraordinary situations and/or circumstances. In the latter case, the joining can be intended to remain joined for a long, indefinite period until the extraordinary circumstances arise.

It should be appreciated that the components can be joined together using any type of fastening method and/or fastener. The fastening method refers to the way the components are joined. A fastener is generally a separate component used in a mechanical fastening method to mechanically join the components together. A list of examples of fastening methods and/or fasteners is given below. The list is divided according to whether the fastening method and/or fastener is generally permanent, readily released, or difficult to release. A general reference to fastening or fasteners without specifying a particular fastening method(s) or fastener(s) should be interpreted as including any type of fastening method and/or fastener.

Examples of permanent fastening methods include welding, soldering, brazing, crimping, riveting, stapling, stitching, some types of nailing, some types of adhering, and some types of cementing. Examples of permanent fasteners include some types of nails, some types of dowel pins, most types of rivets, most types of staples, stitches, most types of structural ties, and toggle bolts.

Examples of readily releasable fastening methods include clamping, pinning, clipping, latching, clasping, buttoning, zipping, buckling, and tying. Examples of readily releasable fasteners include snap fasteners, retainer rings, circlips, split pin, linchpins, R-pins, clevis fasteners, cotter pins, latches, hook and loop fasteners (VELCRO), hook and eye fasteners, push pins, clips, clasps, clamps, zip ties, zippers, buttons, buckles, split pin fasteners, and/or confirmat fasteners.

Examples of difficult to release fastening methods include bolting, screwing, most types of threaded fastening, and some types of nailing. Examples of difficult to release fasteners include bolts, screws, most types of threaded fasteners, some types of nails, some types of dowel pins, a few types of rivets, a few types of structural ties.

It should be appreciated that the fastening methods and fasteners are categorized above based on their most common configurations and/or applications. The fastening methods and fasteners can fall into other categories or multiple categories depending on their specific configurations and/or applications. For example, rope, string, wire, cable, chain, or the like can be permanent, readily releasable, or difficult to release depending on the application.

### Drawing Related Terminology and Interpretative Conventions

Reference numbers in the drawings and corresponding description refer to identical or similar elements although such numbers may be referenced in the context of different embodiments.

The drawings are intended to illustrate embodiments that are both drawn to scale and/or not drawn to scale. This means the drawings can be interpreted, for example, as showing: (a) everything drawn to scale, (b) nothing drawn to scale, or (c) one or more features drawn to scale and one or more features not drawn to scale. Accordingly, the drawings can serve to provide support to recite the sizes, proportions, and/or other dimensions of any of the illustrated features either alone or relative to each other. Furthermore, all such sizes, proportions, and/or other dimensions are to be understood as being variable from 0-100% in either direction and thus provide support for claims that recite such values or any ranges or subranges that can be formed by such values.

Spatial or directional terms, such as “left,” “right,” “front,” “back,” or the like, relate to the subject matter as it is shown in the drawings and/or how it is commonly oriented during manufacture, use, or the like. However, it is to be understood that the described subject matter may assume various alternative orientations and, accordingly, such terms are not to be considered as limiting.

### INCORPORATION BY REFERENCE

The entire content of each document listed below is incorporated by reference into this document (the documents below are collectively referred to as the “incorporated documents”). If the same term is used in both this document and one or more of the incorporated documents, then it should be interpreted to have the broadest meaning imparted by any one or combination of these sources unless the term has been explicitly defined to have a different meaning in this document. If there is an inconsistency between any incorporated document and this document, then this document shall govern. The incorporated subject matter should not be used to limit or narrow the scope of the explicitly recited or depicted subject matter.

Priority patent documents incorporated by reference:
U.S. Prov. App. No. 63/506,365, titled “Electric Vehicle Cable Boom and Charger Mount,” filed on 6 Jun. 2023.

Additional documents incorporated by reference:
“Product Catalog 24,” Custom Aluminum Framing Systems, 80/20 LLC (820 pp.).

What is claimed is:

1. A cable management system for an electric vehicle charger, the cable management system comprising:
a base structured to be coupled to a ceiling of a structure;
a support column slidingly coupled to and extending downward from the base; and
an arm rotatably coupled to the support column and extending horizontally or approximately horizontally outward from the support column.

2. The cable management system of claim 1 wherein the support column is structured to be fixed to the base at multiple locations along the length of the base.

3. The cable management system of claim 1 wherein the support column slides along the length of the base.

4. The cable management system of claim 3 wherein the support column includes a mount that slides along the length of the base.

5. The cable management system of claim 1 wherein the base includes a channel and the support column slides along the channel.

6. The cable management system of claim 1 wherein the base includes a C-shaped channel and the support column slides along the C-shaped channel.

7. The cable management system of claim 1 wherein the arm comprises a proximal beam rotatably coupled to the support column and a distal beam rotatably coupled to the proximal beam.

8. An electric vehicle charging system comprising:
a cable management system comprising:
a base coupled to a ceiling of a structure;
a support column slidingly coupled to and extending downward from the base; and
an arm rotatably coupled to the support column and extending horizontally or approximately horizontally outward from the support column; and
an electric vehicle charger comprising:
a charge cable coupled to and routed along the support column and the arm; and
a charger plug hanging from a distal end of the arm.

9. The electric vehicle charging system of claim 8 wherein the support column is structured to be fixed to the base at multiple locations along the length of the base.

10. The electric vehicle charging system of claim 8 wherein the support column slides along the length of the base.

11. The electric vehicle charging system of claim 10 wherein the support column includes a mount that slides along the length of the base.

12. The electric vehicle charging system of claim 8 wherein the base includes a channel and the support column slides along the channel.

13. The electric vehicle charging system of claim 8 wherein the base includes a C-shaped channel and the support column slides along the C-shaped channel.

14. The electric vehicle charging system of claim 8 wherein the arm comprises a proximal beam rotatably coupled to the support column and a distal beam rotatably coupled to the proximal beam.

15. A cable management system for an electric vehicle charger, the cable management system comprising:
a base structured to be coupled to a ceiling of a structure;
a support column coupled to and extending downward from the base; and
an arm rotatably coupled to the support column and extending horizontally or approximately horizontally outward from the support column,
wherein the cable management system is structured to allow a charge cable to be coupled to and routed along the support column and the arm without disconnecting the charge cable from the electric vehicle charger or a charger plug.

16. The cable management system of claim 15 wherein
the support column comprises a rotation stop; and
the arm comprises a rotation limiter;
wherein the rotation limiter contacts the rotation stop to limit rotation of the arm.

17. The cable management system of claim 15 wherein the arm comprises a proximal beam rotatably coupled to the support column and a distal beam rotatably coupled to the proximal beam.

18. An electric vehicle charging system comprising:
a cable management system comprising:
a base coupled to a ceiling of a structure;
a support column coupled to and extending downward from the base; and
an arm rotatably coupled to the support column and extending horizontally or approximately horizontally outward from the support column; and
an electric vehicle charger comprising:
a charge cable coupled to and routed along the support column and the arm; and
a charger plug;
wherein the cable management system is structured to allow the charge cable to be coupled to and routed along the support column and the arm without disconnecting the charge cable from the electric vehicle charger or the charger plug.

19. The electric vehicle charging system of claim 18 wherein
the support column comprises a rotation stop; and
the arm comprises a rotation limiter;
wherein the rotation limiter contacts the rotation stop to limit rotation of the arm.

20. The electric vehicle charging system of claim 18 wherein the arm comprises a proximal beam rotatably coupled to the support column and a distal beam rotatably coupled to the proximal beam.
